(19) United States
(12) Patent Application Publication
(10) Pub. No.: US 2026/0017889 A1
(43) Pub. Date: Jan. 15, 2026

(54) THREE-DIMENSIONAL MODEL GENERATION METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Keyang LUO, Shenzhen (CN)

(21) Appl. No.: 19/333,512

(22) Filed: Sep. 19, 2025

Related U.S. Application Data
(63) Continuation of application No. PCT/CN2024/104448, filed on Jul. 9, 2024.

(30) Foreign Application Priority Data
Sep. 12, 2023 (CN) 202311176543.4

(51) Int. Cl. G06T 17/20; G06F 18/25; G06F 40/279; G06F 40/40

(52) U.S. Cl. CPC G06T 17/20; G06F 18/253; G06F 40/279; G06F 40/40

(57) ABSTRACT

A three-dimensional model generation method includes: obtaining prompt information describing an object category, and determining a target network model matching the object category indicated by the prompt information, the target network model including a first subnetwork model and a second subnetwork model; obtaining a first generation intensity, a second generation intensity, and a generation seed; performing at least one round of first processing based on the first generation intensity and the generation seed by using the first subnetwork model, to obtain an intermediate three-dimensional model; and performing at least one round of second processing based on the second generation intensity and the intermediate three-dimensional model by using the second subnetwork model, to obtain a three-dimensional object model that satisfies a preset resolution condition and that belongs to the object category.

### CROSS-REFERENCES TO RELATED APPLICATIONS

This application is a continuation of PCT Application No. PCT/CN2024/104448, filed on Jul. 9, 2024, which claims priority to Chinese Patent Application No. 2023111765434, filed on Sep. 12, 2023 and entitled “THREE-DIMENSIONAL MODEL GENERATION METHOD AND APPARATUS, COMPUTER DEVICE, AND STORAGE MEDIUM”, the entire contents of all of which are incorporated herein by reference.

### FIELD OF THE TECHNOLOGY

The present disclosure relates to the field of computer technologies, and in particular, to a three-dimensional model generation method and apparatus, a computer device, and a storage medium.

### BACKGROUND OF THE DISCLOSURE

With development of computer vision technologies, three-dimensional model generation becomes an important topic in the field of artificial intelligence generated content (AIGC). It aims to create a corresponding three-dimensional model based on input information provided by a user, and has a broad application prospect in the fields of gaming, film and television, virtual reality, and three-dimensional (3D) printing.

Currently, three-dimensional model generation is at the beginning stage of research. During actual application, information related to a three-dimensional model that needs to be generated, such as image information or voxel information, is usually inputted to a pre-trained model such as a generative adversarial network (GAN) (an adversarial learning-based deep generative network) or an autoregressive model, and the three-dimensional model is randomly generated by using the GAN or the autoregressive model. Although the three-dimensional model can be created by using such a generative model, the created three-dimensional model has poor quality and low precision.

### SUMMARY

The present disclosure provides a three-dimensional model generation method and apparatus, a computer device, a computer-readable storage medium, and a computer program product.

According to a first aspect, the present disclosure provides a three-dimensional model generation method, performed by a computer device. The method includes: obtaining prompt information describing an object category, and determining a target network model matching the object category indicated by the prompt information, the target network model including a first subnetwork model and a second subnetwork model; obtaining a first generation intensity, a second generation intensity, and a generation seed, the first generation intensity indicating a quantity of iteration rounds of first processing to be performed by the first subnetwork model, the second generation intensity indicating a quantity of iteration rounds of second processing to be performed by the second subnetwork model, the generation seed being a randomly generated number, each round of first processing including at least one instance of first encoding/decoding processing, each round of second processing including at least one instance of second encoding/decoding processing, and both first encoding/decoding processing and second encoding/decoding processing including at least encoding processing and decoding processing; performing at least one round of first processing based on the first generation intensity and the generation seed by using the first subnetwork model, to obtain an intermediate three-dimensional model; and performing at least one round of second processing based on the second generation intensity and the intermediate three-dimensional model by using the second subnetwork model, to obtain a three-dimensional object model that satisfies a preset resolution condition and that belongs to the object category.

According to a second aspect, the present disclosure further provides a three-dimensional model generation apparatus, including: a network matching module, configured to obtain prompt information describing an object category, and determine a target network model matching the object category indicated by the prompt information, the target network model including a first subnetwork model and a second subnetwork model; an information obtaining module, configured to obtain a first generation intensity, a second generation intensity, and a generation seed, the first generation intensity indicating a quantity of iteration rounds of first processing to be performed by the first subnetwork model, the second generation intensity indicating a quantity of iteration rounds of second processing to be performed by the second subnetwork model, the generation seed being a randomly generated number, each round of first processing including at least one instance of first encoding/decoding processing, each round of second processing including at least one instance of second encoding/decoding processing, and both first encoding/decoding processing and second encoding/decoding processing including at least encoding processing and decoding processing; a first model generation module, configured to perform at least one round of first processing based on the first generation intensity and the generation seed by using the first subnetwork model, to obtain an intermediate three-dimensional model; and a second model generation module, configured to perform at least one round of second processing based on the second generation intensity and the intermediate three-dimensional model by using the second subnetwork model, to obtain a three-dimensional object model that satisfies a preset resolution condition and that belongs to the object category.

According to a third aspect, the present disclosure further provides a computer device, including a memory and a processor. The memory has a computer program stored therein. The processor, when executing the computer program, implements the operations of the foregoing three-dimensional model generation method.

According to a fourth aspect, the present disclosure further provides a non-transitory computer-readable storage medium, having a computer program stored herein. The computer program, when executed by a processor, causes the operations of the foregoing three-dimensional model generation method to be implemented.

Details of one or more embodiments of the present disclosure will be proposed in the following drawings and descriptions. Other features, objectives, and advantages of the present disclosure will become apparent in the specification, the drawings, and the claims.

### BRIEF DESCRIPTION OF THE DRAWINGS

FIG. 1 is a diagram of an application environment of a three-dimensional model generation method according to an embodiment.

FIG. 2 is a schematic flowchart of a three-dimensional model generation method according to an embodiment.

FIG. 3 is a block flowchart of operations for obtaining a target network model according to an embodiment.

FIG. 4 is a schematic flowchart of operations for determining an object category according to an embodiment.

FIG. 5 is a schematic flowchart of a process of any instance of first encoding/decoding processing according to an embodiment.

FIG. 6 is a block flowchart of generating a rough three-dimensional model according to an embodiment.

FIG. 7 is a diagram of a model structure of a first subnetwork model according to an embodiment.

FIG. 8 is a block flowchart of feature fusion according to an embodiment.

FIG. 9 is a block flowchart of model training according to an embodiment.

FIG. 10 is a schematic diagram of an architecture of a three-dimensional model generation method according to an embodiment.

FIG. 11 is a block diagram of a structure of a three-dimensional model generation apparatus according to an embodiment.

FIG. 12 is a diagram of an internal structure of a computer device according to an embodiment.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

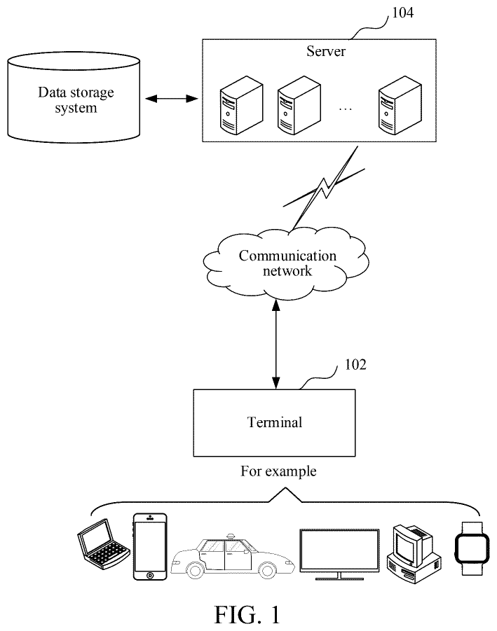

A three-dimensional model generation method provided in an embodiment of the present disclosure may be applied to an application environment shown in FIG. 1. A terminal 102 communicates with a server 104 through a network. A data storage system may store data to be processed by the server 104. The data storage system may be integrated on the server 104, or may be placed on a cloud or another network server. The terminal 102 and the server 104 may be configured to perform the three-dimensional model generation method of the present disclosure alone, or the terminal 102 and the server 104 may be configured to perform the three-dimensional model generation method in the present disclosure cooperatively. An example in which the terminal 102 and the server 104 perform the present disclosure cooperatively is used for description. During an exemplary three-dimensional model generation, a user may edit, with the terminal 102 with reference to a three-dimensional model required by the user, prompt information related to the required three-dimensional model, and transmit the prompt information to the server 104. The server 104 may obtain the prompt information transmitted by the terminal 102, and determine a target network model matching an object category indicated by the prompt information. The target network model includes a first subnetwork model and a second subnetwork model. The server 104 obtains a first encoded feature of a first generation intensity and a second encoded feature of a generation seed. The server 104 performs first encoding/decoding processing based on the first encoded feature and the second encoded feature by using the first subnetwork model, to obtain a rough three-dimensional model (also referred to as an intermediate three-dimensional model). The server 104 obtains a third encoded feature of a second generation intensity, and obtains a fourth encoded feature obtained by encoding the rough three-dimensional model. The server 104 performs second encoding/decoding processing based on the third encoded feature and the fourth encoded feature by using the second subnetwork model, to obtain a three-dimensional object model that satisfies a preset resolution condition and that belongs to the object category. The server 104 may feed back the three-dimensional object model to the terminal 102 for displaying by the terminal 102.

The terminal 102 may be but is not limited to various desktop computers, notebook computers, smartphones, tablet computers, Internet of things devices, portable wearable devices, smart voice interaction devices, smart appliances, in-vehicle terminals, aircrafts, or the like. The Internet of things device may be a smart speaker, a smart television, a smart air conditioner, a smart in-vehicle device, or the like. The portable wearable device may be a smartwatch, a smart band, a head-mounted device, or the like. The server 104 may be implemented by using an independent server or a server cluster including a plurality of servers. The server may be implemented by using an independent server, a server cluster including a plurality of servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. The terminal and the server may be connected directly or indirectly in a wired or wireless communication manner. This embodiment of the present disclosure may be applied to various scenarios, including but not limited to a cloud technology, artificial intelligence, intelligent transportation, assisted driving, and the like.

Artificial intelligence (AI) in the present disclosure is a theory, method, technology, and application system that uses a digital computer or a machine controlled by a digital computer to simulate, extend, and expand human intelligence, perceive an environment, obtain knowledge, and use knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study design principles and implementation methods of various intelligent machines, to enable the machines to have functions of perception, reasoning, and decision-making.

The artificial intelligence technology is a comprehensive discipline, and relates to a wide range of fields including both hardware-level technologies and software-level technologies. Basic artificial intelligence technologies generally include technologies such as a sensor, a dedicated artificial intelligence chip, cloud computing, distributed storage, a big data processing technology, an operating/interaction system, and electromechanical integration. Artificial intelligence software technologies mainly include several major directions such as a computer vision technology, a voice processing technology, a natural language processing technology, and machine learning/deep learning.

The following describes the three-dimensional model generation method in the present disclosure in detail.

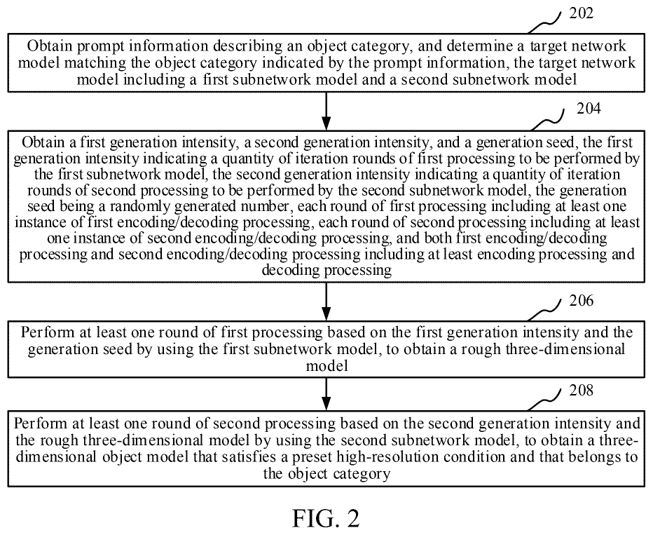

In an exemplary embodiment, as shown in FIG. 2, a three-dimensional model generation method is provided. An example in which the method is applied to a computer device (the computer device may be specifically the terminal 102 or the server 104 in FIG. 1) is used for description. The three-dimensional model generation method includes the following operations.

Operation 202: Obtain prompt information describing an object category, and determine a target network model matching the object category indicated by the prompt information, the target network model including a first subnetwork model and a second subnetwork model.

The prompt information is information for describing the object category, which may be specifically an object identifier; and/or is information for describing an object attribute. Further, the prompt information may be a text, or various identifiers for identification, such as a letter, a number, or a feature code. This is not limited herein. The object category is configured for representing a category to which a to-be-generated three-dimensional object model belongs.

The target network model is a network model constructed based on an artificial intelligence algorithm. The target network model may be configured for generating the three-dimensional object model. During construction, the target network model may be constructed based on a plurality of algorithms such as a supervised learning algorithm and an unsupervised learning algorithm. When the target network model is constructed based on the supervised learning algorithm, the target network model may be constructed based on various generative models such as a diffusion generative model, a variational autoencoder model, and an adversarial generative model.

The target network model includes the first subnetwork model and the second subnetwork model. The first subnetwork model and the second subnetwork model are two independent network models. The first subnetwork model is a network model for generating a rough three-dimensional model, and an output of the first subnetwork model may be used as input data of the second subnetwork model, so that the second subnetwork model may further optimize the rough three-dimensional model based on the rough three-dimensional model generated by the first subnetwork model, to obtain a three-dimensional object model with better quality, improving three-dimensional model generation precision.

Specifically, when obtaining the prompt information transmitted by a terminal, the computer device may perform category determining on the prompt information, to determine the object category indicated by the prompt information, and further obtain the target network model matching the object category. The target network model includes the first subnetwork model and the second subnetwork model.

In some embodiments, the computer device may perform word segmentation processing on the prompt information by using a word segmentation tool, to determine various types of words in the prompt information, such as a noun, an entity word, a non-noun, and a stop word. Further, the computer device may remove the stop word and a non-noun word. The stop word is a word having no actual meaning, such as a pronoun, an auxiliary word, an adjective, or an adverb. The computer device retains the entity word and the noun, such as a word having an actual meaning like an object name and a size, and uses the retained entity word and noun as keywords. Further, the computer device may perform category analysis based on the determined keyword, to determine the object category indicated by the prompt information.

In some embodiments, the computer device may perform category analysis on the prompt information by using an algorithm that can implement object category recognition. A plurality of algorithms may be used, such as a similarity analysis algorithm, a decision tree algorithm, and a support vector machine algorithm.

In some embodiments, the computer device may obtain, through query based on the determined object category indicated by the prompt information, the target network model to which the object category belongs. For example, the computer device may pre-construct a corresponding network model library for various types of network models and object categories corresponding to various types of network models. The network model library records a correspondence between a network model and an object category. Further, when obtaining the target network model based on the object category, the computer device may obtain the target network model from the network model library through query based on an actual requirement. In some embodiments, when not finding the target network model matching the object category, the computer device may output feedback information indicating a search failure to a user, so that the user may adjust the prompt information based on the feedback information. Alternatively, the computer device may reselect a keyword to perform category determining to determine a new object category, and obtain the target network model based on the new object category.

Operation 204: Obtain a first generation intensity, a second generation intensity, and a generation seed, the first generation intensity indicating a quantity of iteration rounds of first processing to be performed by the first subnetwork model, the second generation intensity indicating a quantity of iteration rounds of second processing to be performed by the second subnetwork model, the generation seed being a randomly generated number, each round of first processing including at least one instance of first encoding/decoding processing, each round of second processing including at least one instance of second encoding/decoding processing, and both first encoding/decoding processing and second encoding/decoding processing including at least encoding processing and decoding processing.

A generation intensity is information for indicating a quantity of model iteration rounds. In some embodiments, a higher generation intensity may indicate a larger quantity of model iteration rounds and better effects of a finally generated three-dimensional model.

The first generation intensity is configured for indicating the quantity of iteration rounds of first processing to be performed by the first subnetwork model. One or more instances of first processing may be performed. When the first generation intensity is set, the first generation intensity may be specifically determined with reference to a dimension of the to-be-generated three-dimensional model such as quality and generation efficiency.

The second generation intensity is configured for indicating the quantity of iteration rounds of second processing to be performed by the second subnetwork model. One or more instances of second processing may be performed. When the second generation intensity is set, the second generation intensity may be specifically determined with reference to the dimension of the to-be-generated three-dimensional model such as the quality and the generation efficiency.

The generation seed is the randomly generated number. The random number may be a randomly generated natural number, specifically a natural number randomly selected from a set range.

First processing may include the at least one instance of first encoding/decoding processing, and first encoding/decoding processing includes at least an encoding processing process and a decoding processing process. Second processing may include the at least one instance of second encoding/decoding processing, and second encoding/decoding processing includes at least an encoding processing process and a decoding processing process. First processing may be the same as or different from second processing, and first encoding/decoding processing may be the same as or different from second encoding/decoding processing.

Specifically, the computer device may select a natural number from a set natural number range based on the natural number range, and determine the first generation intensity, the second generation intensity, and the generation seed based on the selected natural number. Alternatively, the first generation intensity, the second generation intensity, and the generation seed may be determined by a natural number carried in the prompt information. The computer device may parse the prompt information to obtain the first generation intensity, the second generation intensity, and the generation seed. Alternatively, the computer device may query, with reference to the object category corresponding to the target network model, a database directly based on the object category, to obtain the first generation intensity, the second generation intensity, and the generation seed. The database may pre-store an association relationship between an object category of each category of object and a first generation intensity, a second generation intensity, and a generation seed.

In some embodiments, the natural number carried in the prompt information may specify only one or two of the first generation intensity, the second generation intensity, and the generation seed. In this case, the computer device may select a natural number based on a set natural number range, and assign a value to unspecified data in the first generation intensity, the second generation intensity, and the generation seed based on the selected natural number.

In some embodiments, the computer device may obtain the first generation intensity, the second generation intensity, and the generation seed based on a natural number range. The natural number range may include a first generation intensity range, a second generation intensity range, and a generation seed range. The first generation intensity range, the second generation intensity range, and the generation seed range may be the same or different. For example, the first generation intensity range may be set to 0 to 20, the second generation intensity range may be set to 20 to 50, and the generation seed range may be set to 100 to 150. The first generation intensity obtained by the computer device may be 13, the second generation intensity may be 30, and the generation seed may be 90.

Operation 206: Perform at least one round of first processing based on the first generation intensity and the generation seed by using the first subnetwork model, to obtain the rough three-dimensional model.

First encoding/decoding processing includes at least an encoding processing process and a decoding processing process. First processing may include the at least one instance of first encoding/decoding processing. During first processing, a first encoded feature needed in a current round of first encoding/decoding processing process may be determined based on the first generation intensity. During a first round of first processing, a second encoded feature needed to perform a first instance of first encoding/decoding processing may be determined based on the generation seed.

The rough three-dimensional model is a three-dimensional model obtained by performing the at least one round of first processing by using the first subnetwork model. The rough three-dimensional model may form an approximate shape of the to-be-generated three-dimensional object model.

Specifically, the computer device may determine, based on the first generation intensity, a first encoded feature needed in a first encoding/decoding processing process of each round of first processing, and determine, based on the generation seed, the second encoded feature needed to perform the first instance of first encoding/decoding processing in the first round of first processing; and then perform encoding/decoding processing on the first encoded feature and the second encoded feature by using the first subnetwork model, to obtain the rough three-dimensional model.

In some embodiments, in a process in which the computer device performs encoding/decoding processing by using the first subnetwork model, when a plurality of instances of first processing are performed, and each instance of first processing includes a plurality of instances of first encoding/decoding processing, the first encoded feature is updated with a round number of first processing, that is, first encoded features in a same round are the same, and first encoded features in different rounds are different. The second encoded feature is updated based on a change of the first encoding/decoding processing process, that is, second encoded features in different first encoding/decoding processing processes in a same round are different. In a same round, a second encoded feature in a subsequent instance of first encoding/decoding processing is determined by an output of a previous instance of first encoding/decoding processing, and when the previous instance of first encoding/decoding processing is the first instance of first encoding/decoding processing in the first round, a second encoded feature in the previous instance of first encoding/decoding processing is determined by the generation seed.

In some embodiments, the computer device may encode the first generation intensity to determine the first encoded feature, and encode the generation seed to obtain the second encoded feature needed to perform the first instance of first encoding/decoding processing in the first round of first processing. The computer device may perform encoding based on a linear neural network, a three-dimensional convolutional network, and the like or by using another equivalent operator instead of the linear neural network and the three-dimensional convolutional network. This is not limited herein.

Operation 208: Perform at least one round of second processing based on the second generation intensity and the rough three-dimensional model by using the second subnetwork model, to obtain the three-dimensional object model that satisfies a preset resolution condition and that belongs to the object category.

Second encoding/decoding processing includes at least an encoding processing process and a decoding processing process. Second processing may include the at least one instance of second encoding/decoding processing. During second processing, a third encoded feature needed in a current round of second encoding/decoding processing process may be determined based on the second generation intensity. The rough three-dimensional model may be configured for determining a fourth encoded feature needed to perform a first instance of second encoding/decoding processing in a first round of second processing.

The preset resolution condition is a condition for determining whether a resolution of the generated three-dimensional object model satisfies a model quality requirement. The preset resolution condition may be set based on a set resolution threshold. To be specific, when the resolution of the generated three-dimensional object model reaches the resolution threshold, the preset resolution condition is satisfied.

Specifically, the computer device may determine, based on the second generation intensity, a third encoded feature needed in a second encoding/decoding processing process of each round of second processing, and determine, based on the rough three-dimensional model, the fourth encoded feature needed to perform the first instance of second encoding/decoding processing in the first round of second processing; and then perform encoding/decoding processing on the third encoded feature and the fourth encoded feature by using the second subnetwork model, to obtain the three-dimensional object model that satisfies the preset resolution condition and that belongs to the object category.

In some embodiments, the computer device may encode the second generation intensity to determine the third encoded feature, and encode the rough three-dimensional model to determine the fourth encoded feature needed to perform the first instance of second encoding/decoding processing in the first round of second processing. The computer device may perform encoding based on the linear neural network, the three-dimensional convolutional network, and the like or by using another equivalent operator instead of the linear neural network and the three-dimensional convolutional network. This is not limited herein.

In some embodiments, in a process in which the computer device performs encoding/decoding processing by using the second subnetwork model, when a plurality of instances of second processing are performed, and each instance of second processing includes a plurality of instances of second encoding/decoding processing, the third encoded feature is updated with a round number of second processing, that is, third encoded features in a same round are the same, and third encoded features in different rounds are different. The fourth encoded feature is updated based on a change of the second encoding/decoding processing process, that is, fourth encoded features in different second encoding/decoding processing processes in a same round are different. In a same round, a fourth encoded feature in a subsequent instance of second encoding/decoding processing is determined by an output of a previous instance of second encoding/decoding processing, and when the previous instance of second encoding/decoding processing is the first instance of second encoding/decoding processing in the first round, a fourth encoded feature in the previous instance of second encoding/decoding processing is determined by the rough three-dimensional model.

In the foregoing three-dimensional model generation method, when the prompt information is obtained, a search may be performed for the target network model matching the object category indicated by the prompt information, and a high-precision three-dimensional object model of a category required by the user is generated by using the found target network model. In a process of generating the three-dimensional object model by using the target network model, the first generation intensity, the second generation intensity, and the generation seed are obtained, and then the at least one round of first processing is performed on the first generation intensity and the generation seed based on the first subnetwork model in the target network model. First processing includes the at least one instance of encoding/decoding processing. In this way, the rough three-dimensional model may be obtained. The rough three-dimensional model determines the approximate shape of the to-be-generated three-dimensional object model. Further, the at least one round of second processing is performed on the second generation intensity and the rough three-dimensional model by using the second subnetwork model in the target network model. Each round of second processing includes the at least one instance of second encoding/decoding processing. In this way, the three-dimensional object model that satisfies the preset resolution condition and that belongs to the object category is obtained. The three-dimensional object model is a model obtained by optimizing the rough three-dimensional model. In this way, a model generation process is divided into two phases: rough model generation and fine model generation. The rough model generation phase is responsible for generating the approximate shape of the model, and the fine model generation phase is responsible for optimizing a three-dimensional model generation result. Therefore, generation quality of the three-dimensional object model can be significantly improved, that is, generation precision of the three-dimensional object model is improved.

In some embodiments, the determining a target network model matching the object category indicated by the prompt information includes: determining the object category indicated by the prompt information; and obtaining the target network model matching the object category from a network model pool, the network model pool including a plurality of trained network models for generating three-dimensional object models of multiple categories, and the target network model being configured to generate a three-dimensional object model belonging to the object category indicated by the prompt information.

The network model pool stores a plurality of pre-trained network models for generating three-dimensional object models of multiple categories. The target network model is a network model that is selected from the network model pool and that matches the object category indicated by the prompt information, and may be configured for generating the three-dimensional object model belonging to the object category indicated by the prompt information.

Specifically, the computer device may perform similarity analysis based on the prompt information and preset category information, to determine the object category. The category information is information related to an object matching the network model stored in the network model pool. The computer device may perform similarity analysis in a manner of calculating a cosine similarity, an edit distance, a similarity coefficient, or the like, to obtain a similarity analysis result, and determine the object category based on the similarity analysis result. Further, the computer device may obtain the target network model matching the object category from the network model pool based on the object category indicated in the similarity analysis result.

In some embodiments, the category information may be an object name, an object identifier, or other information for describing the object matching the network model stored in the network model pool.

In some embodiments, when constructing the target network model, the computer device may construct a corresponding network model for each category of object. For example, for a chair, a network model corresponding to the chair may be constructed. For a desk, a network model corresponding to the desk may be constructed. For a game character, a network model corresponding to the game character may be constructed. Further, the computer device may store the network model constructed for each category of object in the network model pool or a preset model library. The network model pool stores an association relationship between an object category and a network model. When a three-dimensional model actually needs to be generated, the three-dimensional model may be directly obtained from the network model pool or the model library based on an object category.

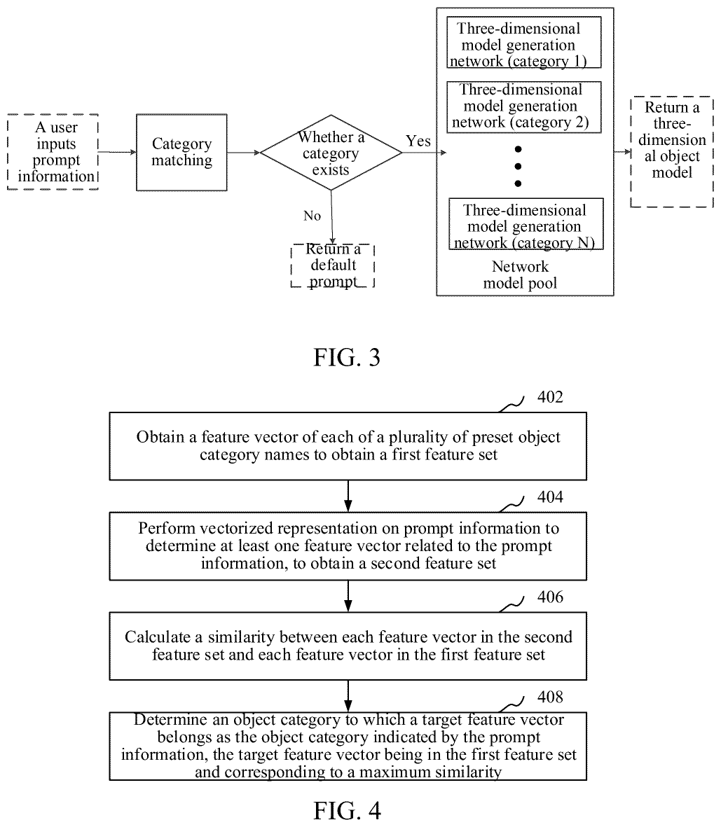

In some embodiments, FIG. 3 is a block flowchart of obtaining the target network model in the three-dimensional model generation method. First, the user may input the prompt information. The prompt information is configured for providing a modeling prompt. For example, the prompt information inputted by the user may be “a chair”. When obtaining the prompt information inputted by the user, the computer device performs category matching based on the prompt information, to determine the object category in the prompt information, and searches, in the network model pool based on the object category, for the target network model matching the object category. If determining that the three-dimensional object model of the object category cannot be generated, the computer device directly returns a default prompt, for example, “The system currently does not support this object category”. If the three-dimensional object model of the object category can be generated, the computer device may obtain the target network model matching the object category from the network model pool. The network model pool includes the plurality of trained network models for generating three-dimensional object models of multiple categories. For example, there is a corresponding three-dimensional model generation network for each of a category 1 to a category N. The computer may generate, based on the target network model, the three-dimensional object model belonging to the object category indicated by the prompt information, and returns the generated three-dimensional object model to a user side.

In the foregoing embodiment, the computer device may determine the object category based on the prompt information, and directly obtain the matching target network model from the network model pool based on the determined object category, to generate, based on the target network model, the three-dimensional object model belonging to the object category indicated by the prompt information. This not only improves three-dimensional model generation precision, but also can improve three-dimensional model generation efficiency.

In some exemplary embodiments, as shown in FIG. 4, the determining the object category indicated by the prompt information includes operation 402 to operation 408.

Operation 402: Obtain a feature vector of each of a plurality of preset object category names to obtain a first feature set.

The first feature set includes the feature vector of each of the plurality of preset object category names. Feature extraction may be performed on each object category name to obtain the corresponding feature vector.

Specifically, the computer device may perform vectorized representation processing on each object category name to obtain the feature vector. Vectorized representation may be implemented by using a language model. Processing with the language model may convert the object category name into a vector representation, so that the computer device may obtain the first feature set based on the vector representation.

In some embodiments, the computer device may perform vectorized representation processing on the object category name based on the language model. For example, the language model may be a bidirectional encoder representations from transformers (BERT) (a bidirectional encoder model), generative pre-trained transformer 3 (GPT3) (a generative pre-trained model), generative pre-trained transformer 4 (GPT4) (a generative pre-trained model), or a contrastive language-image pre-training (CLIP) model. This is not limited in this embodiment of the present disclosure.

In some embodiments, the computer device may perform vectorized representation processing on each object category name based on the BERT model. For example, the network models stored in the network model pool support object categories 1, 2, . . . , and N in total, N being a positive integer greater than or equal to 1. Object category names of the object categories may form an object category name list. The object category name list is C={C₁, C₂, . . . , C_{N}}, where Cₖ represents a k^{th} object category name supported, such as “chair”.

The computer device may extract, based on the BERT model, the feature vector corresponding to each object category name. Specifically, the BERT model may be denoted as Mₙₗₚ, and a calculation formula for a feature vector corresponding to Cₖ may be represented as:

$${F}_{k} = {M}_{nlp} ( {C}_{k} ) .$$

Fₖ is a high-dimensional floating-point vector. The computer device may calculate the feature vector of each object category name by using the feature vector calculation formula, to obtain a feature vector set F={F₁, F₂, . . . , F_{N}} of all the object category names.

Operation 404: Perform vectorized representation on the prompt information to determine at least one feature vector related to the prompt information, to obtain a second feature set.

Based on the prompt information, only one feature vector may be extracted, or a plurality of feature vectors may be extracted. The second feature set is obtained by using the at least one feature vector extracted from the prompt information.

Specifically, the computer device may process the prompt information to determine information for vectorized representation, to obtain the second feature set. When processing the prompt information, the computer device may extract at least one keyword in the prompt information, to perform vectorized representation processing based on the at least one keyword extracted, to determine a feature vector corresponding to the at least one keyword. Alternatively, the computer device may directly perform vectorized representation processing on the prompt information to obtain the feature vector corresponding to the prompt information.

In some embodiments, when extracting the keyword in the prompt information, the computer device may extract the keyword through word segmentation, or may extract the keyword in the prompt information by using another method such as DeepText (a deep learning-based text understanding engine) and content classification.

In some embodiments, the performing vectorized representation on the prompt information to determine at least one feature vector related to the prompt information, to obtain a second feature set includes: performing word segmentation processing on the prompt information to obtain a plurality of word units in the prompt information; and extracting a feature vector of the prompt information and a feature vector of each word unit to obtain the second feature set.

The word unit is a single word segment obtained by performing word segmentation processing on the prompt information. The word segment may be various types of words such as a noun, an entity word, and a non-noun.

Specifically, the computer device may perform word segmentation processing on the prompt information by using a word segmentation tool, to obtain the plurality of word units, perform vectorized representation processing based on the obtained word units, to obtain the feature vectors of the word units, perform vectorized representation processing based on the prompt information, to obtain the feature vector of the prompt information, and further obtain the second feature set based on the obtained feature vectors.

In some embodiments, the prompt information obtained by the computer device may be a short sentence S. The computer device performs word segmentation processing on the short sentence S to obtain a plurality of word units corresponding to the short sentence S. For example, the obtained short sentence may include Z words. The inputted short sentence may be represented as S={S₁, S₂, . . . , S_{Z}}. Further, the computer device may separately extract, by using the language model, for example, by using the BERT model, feature vectors corresponding to S, S₁, S₂, . . . , S_{Z} to obtain the second feature set. The second feature set is denoted as

$${F}^{′} = \{ {F}_{0}^{′} , {F}_{1}^{′} ... {F}_{Z}^{′} \} , where {F}_{0}^{′} = {M}_{nlp} ( S ) , {F}_{j}^{′} = {M}_{nlp} ( {S}_{j} ) , and 1 \leq j \leq Z .$$

Operation 406: Calculate a similarity between each feature vector in the second feature set and each feature vector in the first feature set.

The similarity is a parameter for representing a level of similarity between each feature vector in the first feature set and each feature vector in the second feature set.

Specifically, the computer device may calculate the similarity between each feature vector in the second feature set and each feature vector in the first feature set.

As described above, the computer device may perform vectorized representation processing on the object category name to obtain the first feature set F, and perform vectorized representation processing on the prompt information to obtain the second feature set F′. For any feature vector

$${F}_{j}^{′}$$

in F′, the computer device may calculate a similarity Qⱼₖ between the feature vector and any feature vector Fₖ in F:

$${Q}_{jk} = \frac{{F}_{j}^{′} \cdot {F}_{k}}{‖ {F}_{j}^{′} ‖ ‖ {F}_{k} ‖}$$

0≤Qⱼₖ≤1. A quantity of similarities depends on quantities of feature vectors in the first feature set F and in the second feature set F′.

Operation 408: Determine an object category to which a target feature vector belongs as the object category indicated by the prompt information, the target feature vector being in the first feature set and corresponding to a maximum similarity. In some embodiments, the maximum similarity satisfies a preset similarity condition.

The preset similarity condition is a condition set for determining, based on the similarity, whether the target network model matching the object category indicated by the indication information exists in the network model pool. When the preset similarity condition is set, an adaptive adjustment may be performed with reference to a quality requirement of the to-be-generated three-dimensional model, a type of the language model, and the like.

Specifically, the computer device may select a target similarity from the similarities obtained through calculation, and determine, based on the target similarity, whether the preset similarity condition is satisfied. When the preset similarity condition is satisfied, the computer device may determine the object category to which the feature vector that is in the first feature set and that corresponds to the maximum similarity belongs as the object category indicated by the prompt information. The target similarity selected by the computer device may be the maximum similarity in the similarities, a similarity in the similarities whose value is greater than a set threshold, or the like. A selection manner for the target similarity is not limited herein.

In some embodiments, the computer device may determine the maximum similarity in the plurality of similarities obtained as the target similarity. The preset similarity condition may be determined by a preset similarity threshold set based on the type of the language model. In other words, when the target similarity reaches the preset similarity threshold, the preset similarity condition is satisfied. For example, the preset similarity threshold may be set to 0.97. If the target similarity selected by the computer device is 0.98, the preset similarity condition is satisfied.

In some other embodiments, the computer device may select similarities whose values reach the threshold as target similarities, and when a part of the selected similarities reach the preset similarity threshold, determine that the preset similarity condition is satisfied. For example, the similarities selected by the computer device may be 0.7, 0.95, and 0.98, the preset similarity threshold is 0.94, and there are two similarities greater than the preset similarity threshold. In this case, the computer device may determine that the preset similarity condition is satisfied.

In the foregoing embodiment, the computer device obtains the first feature set and the second feature set, and calculates the similarity between the feature vectors in the first feature set and the second feature set. Therefore, the object category indicated by the prompt information can be accurately determined, ensuring the quality of the three-dimensional object model and improving the precision of generating the three-dimensional object model.

In some exemplary embodiments, operation 206, that is, the operation of performing at least one round of first processing based on the first generation intensity and the generation seed by using the first subnetwork model, to obtain the rough three-dimensional model includes: determining a first quantity of times based on the first generation intensity, performing first processing for the first quantity of times by using the first subnetwork model, and obtaining the rough three-dimensional model based on an output of a last instance of first processing, each round of first processing including at least two instances of first encoding/decoding processing.

The first quantity of times is a determined quantity of times of performing first processing by using the first subnetwork model. Usually, a larger value of the first quantity of times indicates a larger quantity of times of performing first processing by using the first subnetwork model and better quality and higher precision of the obtained rough three-dimensional model.

Specifically, the computer device determines, based on the first generation intensity, the first quantity of times of performing first processing, to perform iterative processing on the first subnetwork model based on the first quantity of times, and determine an output of a last instance of first processing as the rough three-dimensional model.

In some embodiments, the first generation intensity may be specifically a value. The computer device may directly use the first generation intensity as the first quantity of times, or obtain the first quantity of times by performing a mathematical operation on the first generation intensity. The mathematical operation performed herein may be, for example, doubling processing or adding a preset value. The preset value may be, for example, 1, 2, or another value.

In one embodiment, for example, the first generation intensity is 1, and the computer device may add 1 to 1 to obtain a first quantity of times of 2. When the first quantity of times is 2, the first subnetwork model needs to perform two instances of first processing, including the first instance of first processing and the second instance of first processing, each instance of first processing including at least two instances of first encoding/decoding processing.

In some embodiments, the computer device may perform convolution processing on the output of the last instance of first processing, to transform a dimension of a feature vector outputted by the last instance of first processing, to obtain the rough three-dimensional model, so that the obtained rough three-dimensional model can meet an input requirement of the second subnetwork model, improving subsequent processing accuracy of the second subnetwork model. When performing convolution processing on the output, the computer device may perform processing based on three-dimensional convolution, depthwise separable convolution, or the like, or by using another deep learning operator instead.

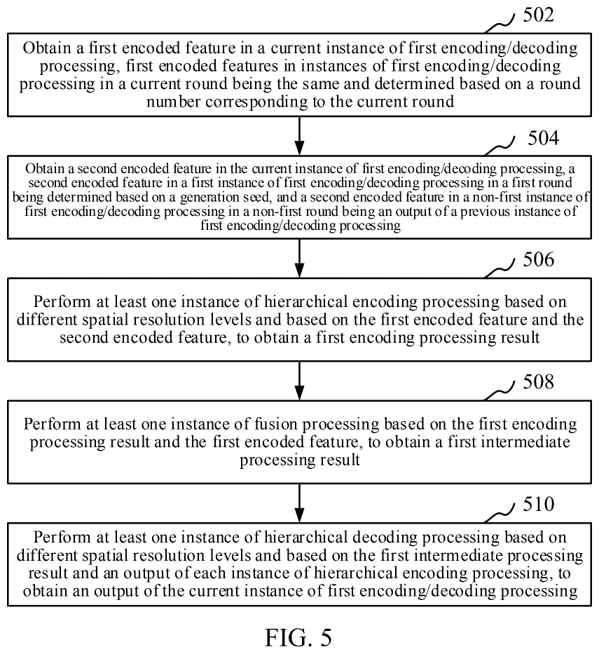

In some embodiments, each round of first processing includes at least two instances of first encoding/decoding processing. Refer to FIG. 5. A process of any instance of first encoding/decoding processing in any current round includes the following steps:

Operation 502: Obtain a first encoded feature in the current instance of first encoding/decoding processing, first encoded features in instances of first encoding/decoding processing in the current round being the same and determined based on a round number corresponding to the current round.

Operation 504: Obtain a second encoded feature in the current instance of first encoding/decoding processing, the second encoded feature in the first instance of first encoding/decoding processing in the first round being determined based on the generation seed, and a second encoded feature in a non-first instance of first encoding/decoding processing in a non-first round being an output of a previous instance of first encoding/decoding processing.

Operation 506: Perform at least one instance of hierarchical encoding processing based on different spatial resolution levels and based on the first encoded feature and the second encoded feature, to obtain a first encoding processing result.

The first subnetwork model may include at least one encoding layer, and hierarchical encoding processing is performing encoding processing on each encoding layer. There is a corresponding output spatial resolution for each encoding layer. Voxel spatial resolutions for different encoding layers may be different or the same. The voxel spatial resolutions may be adaptively set with reference to a requirement for three-dimensional model generation precision, a computing resource of the computer device, and the like.

Operation 508: Perform at least one instance of fusion processing based on the first encoding processing result and the first encoded feature, to obtain a first intermediate processing result.

At least one connection layer may be further disposed between the encoding layer and a decoding layer of the first subnetwork model, and each connection layer may be configured for connecting the encoding layer to the decoding layer. The first intermediate processing result is determined based on a fusion result obtained by the connection layer by performing fusion processing on the first encoding processing result and the first encoded feature.

Operation 510: Perform at least one instance of hierarchical decoding processing based on different spatial resolution levels and based on the first intermediate processing result and an output of each instance of hierarchical encoding processing, to obtain an output of the current instance of first encoding/decoding processing.

The first subnetwork model may further include at least one decoding layer, and hierarchical decoding processing is performing decoding processing on each decoding layer. There are corresponding spatial resolution levels for different decoding layers. In other words, a voxel spatial resolution is set for each decoding layer. Voxel spatial resolutions for different decoding layers may be different or the same.

Specifically, in the process of the any instance of first encoding/decoding processing in the current round, the computer device may determine the first encoded feature based on the round number corresponding to the current round. For the second encoded feature, if the current round is the first round, and the second encoded feature is for the first instance of first encoding/decoding processing in the first round, the computer device may determine the second encoded feature based on the generation seed; or if the second encoded feature is not for the first instance of first encoding/decoding processing in the first round, the computer device may determine the second encoded feature based on the output of the previous instance of first encoding/decoding processing.

Further, for the process of the any instance of first encoding/decoding processing in the current round, the computer device may perform hierarchical encoding processing on the first encoded feature and the second encoded feature by using the at least one encoding layer that is in the first subnetwork model and for which the spatial resolution level is set, to obtain the first encoding processing result. Based on obtaining the first encoding processing result, the computer device may perform the at least one instance of feature fusion processing on the first encoded feature and the first encoding processing result by using the connection layer in the first subnetwork model, to obtain the first intermediate processing result. Further, the computer device may perform hierarchical decoding processing on the first intermediate processing result and the output of each instance of hierarchical encoding processing by using the at least one decoding layer that is in the first subnetwork model and for which the spatial resolution level is set, to obtain the output of the current instance of first encoding/decoding processing.

In some embodiments, the voxel spatial resolution corresponding to the encoding layer may decrease as the layer increases. The first subnetwork model may include a preset quantity of encoding layers, for example, five encoding layers. The voxel spatial resolutions may be set to 64³, 32³, 16³, 8³, 4³ based on a sequence of performing hierarchical encoding. The voxel spatial resolution corresponding to the decoding layer increases as the layer increases. The first subnetwork model may include a preset quantity of decoding layers, for example, five decoding layers. The voxel spatial resolutions may be set to 4³, 8³, 16³, 32³, 64³ based on a sequence of performing hierarchical decoding.

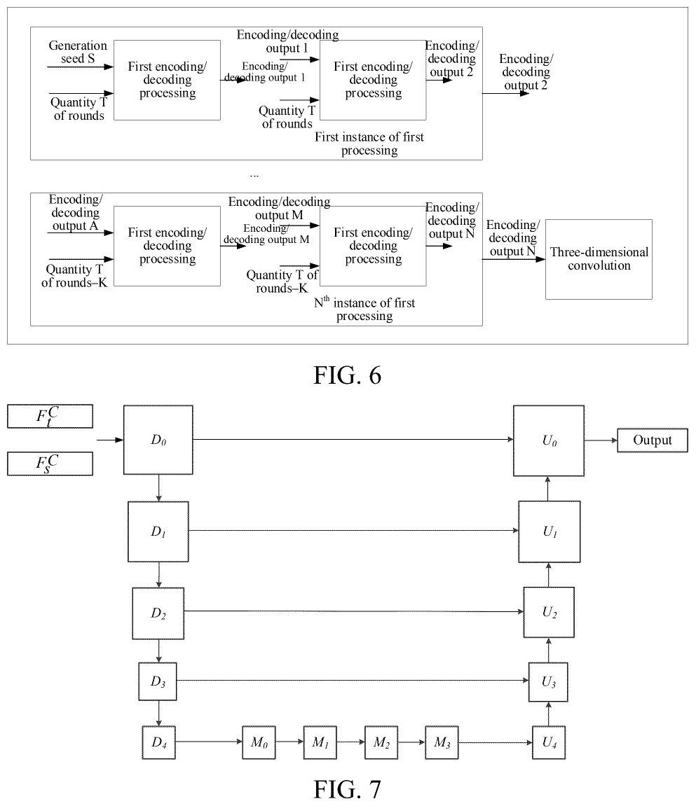

In some embodiments, FIG. 6 is a block flowchart of obtaining the rough three-dimensional model. In FIG. 6, the computer device may perform N instances of first processing based on the first subnetwork model, N being greater than or equal to 1. The first instance of first processing may include two first encoding/decoding processing processes, and an N^{th} instance of first processing may also include two first encoding/decoding processing processes. For the first instance of first encoding/decoding processing, an input is a first encoded feature obtained based on a quantity T of rounds determined based on the first generation intensity and a second encoded feature determined based on the generation seed S, and an output is an encoding/decoding output 1. In a process of the second instance of first encoding/decoding processing of first processing, the first encoded feature remains unchanged, and a second encoded feature is determined based on the encoding/decoding output 1 of first encoding/decoding processing in the same round. For the N^{th} instance of first processing, input data of the first instance of encoding/decoding processing is a first encoded feature determined based on the quantity T of rounds-K and a second encoded feature determined based on an output of a previous instance of first encoding/decoding output, and an output is an encoding/decoding output M, where T and K are both greater than or equal to 0, and K is less than or equal to T. In the second instance of first encoding/decoding processing, the first encoded feature remains unchanged, and a second encoded feature is determined based on the encoding/decoding output M of first encoding/decoding processing in the same round. The computer device may perform a three-dimensional convolution operation on an encoding/decoding output N, to obtain the rough three-dimensional model.

In the foregoing embodiment, the computer device performs the at least one round of first processing based on the first generation intensity and the generation seed by using the first subnetwork model, to obtain the rough three-dimensional model. The rough three-dimensional model may reflect the approximate shape of the to-be-generated three-dimensional object model. Therefore, the generated rough three-dimensional model may be subsequently optimized, to improve the three-dimensional model generation precision.

In some embodiments, determining operations for the first encoded feature in the current round include: determining a first value to be encoded in the current round based on the round number of the current round; expanding the first value into a feature vector of a preset dimension; and performing at least one linear transformation on the feature vector of the preset dimension to obtain the first encoded feature.

The first value is encoded data determined by the round number of the current round. Specifically, a value corresponding to the round number may be determined as the first value.

Specifically, the computer device determines the first value based on the round number of the current round, and performs dimension expansion on the first value to expand the first value into a high-dimensional feature vector. A dimension of the feature vector may be preset, for example, may be any dimension such as 32 dimensions, 64 dimensions, or 128 dimensions. The computer device may further perform the at least one linear transformation on the high-dimensional feature vector to obtain the first encoded feature.

In some embodiments, the computer device may encode the first value into the high-dimensional feature vector according to the following formula:

$${f}_{t}^{c} ( {t}_{c} ) = \{ {t}_{c} , sin ( {t}_{c} \cdot {w}_{c}^{0} \cdot 2 π ) , cos ( {t}_{c} \cdot {w}_{c}^{0} \cdot 2 π ) , sin ( {t}_{c} \cdot {w}_{c}^{1} \cdot 2 π ) , ... , cos ( {t}_{c} \cdot {w}_{c}^{15} \cdot 2 π ) \} \{ {w}_{c}^{0} , {w}_{c}^{1} , ... , {w}_{c}^{15} \}$$

is a 16-dimensional floating-point number vector obtained through training. sin and cos are a sine function and a cosine function. Therefore,

$${f}_{t}^{c} ( {t}_{c} )$$

is a 33-dimensional feature vector. Further, a high-dimensional feature vector

$${F}_{t}^{c}$$

is obtained through two layers of linear neural networks:

$${F}_{t}^{c} = {linear}_{2} ( Si L U ( {linear}_{1} ( {f}_{t}^{c} ( {t}_{c} ) ) ) )$$

SiLU is an activation function. linear₁ and linear₂ are an R³³→R¹²⁸ linear neural network and an R¹²⁸→R¹²⁸ linear neural network. The high-dimensional feature vector

$${F}_{t}^{c}$$

is the first encoded feature.

In the foregoing embodiment, the computer device determines the first value in the current round based on the round number of the current round, expands the first value into the feature vector of the preset dimension, and performs the at least one linear transformation on the feature vector of the preset dimension. Therefore, the obtained first encoded feature satisfies an input requirement of the first subnetwork model, improving model processing accuracy of the first subnetwork model.

In some embodiments, determining operations for the second encoded feature in the first instance of first encoding/decoding processing in the first round include: generating a first tensor of a preset shape based on the generation seed by using a Gaussian function; and performing three-dimensional convolution processing on the first tensor of the preset shape to obtain the second encoded feature located within a three-dimensional space.

Specifically, the first tensor is configured for describing a shape of the generation seed in a multi-dimensional space. For determining of the second encoded feature in the first instance of first encoding/decoding processing in the first round, the computer device may encode a 3D model generation space based on the generation seed, to obtain the second encoded feature.

In some embodiments, when encoding the 3D model generation space, the computer device may specifically generate a floating-point type tensor

$${X}_{c}^{0}$$

of a shape of [1, T₀, T₀, T₀] based on the generation seed by using the Gaussian function. All elements of

$${X}_{c}^{0}$$

are 0 to 1. Further, the computer device may process the floating-point type tensor

$${X}_{c}^{0}$$

by using a layer of three-dimensional convolutional network, to obtain a feature code

$${F}_{s}^{c} ( {X}_{c}^{0} )$$

of the generation space.

$${F}_{s}^{c} = Si L U ( B N ( C N {N}_{3 D} ( {X}_{c}^{0} ) ) )$$

CNN_{3D} is a standard three-dimensional convolution operation. BN is batch normalization.

$${F}_{s}^{c}$$

is a floating-point type tensor of a shape of [32, T₀, T₀, T₀]. T₀=64.

$${F}_{s}^{c}$$

is the second encoded feature for the first instance of first encoding/decoding processing in the first round.

In the foregoing embodiment, the computer device generates the first tensor of the preset shape based on the generation seed by using the Gaussian function, and performs three-dimensional convolution processing on the first tensor of the preset shape to obtain the second encoded feature located within the three-dimensional space. Therefore, the obtained second encoded feature meets the input requirement of the first subnetwork model, improving the model processing accuracy of the first subnetwork model.

FIG. 7 is a description of a model structure of the first subnetwork model. The following describes exemplary encoding processing, fusion processing, and decoding processing. In the first subnetwork model shown in FIG. 7,

$${F}_{t}^{c}$$

is the first encoded feature, and

$${F}_{c}^{s}$$

is the second encoded feature. Modules D₀, D₁, D₂, D₃, D₄ are encoding layers. M₀, M₁, M₂, M₃ are connection layers. Modules U₀, U₁, U₂, U₃, U₄ are decoding layers. The modules D₄, M₀, M₁, M₂, M₃, U₀ has no sampling operations, and remaining operations are the same. Sampling operations in the modules U₁, U₂, U₃, U₄ represent three-dimensional convolution upsampling operations. Sampling operations in the modules D₀, D₁, D₂, D₃, D₄ represent three-dimensional convolution downsampling operations. If an operation result obtained by the module U₀ is

$${F}_{out}^{c} ,$$

a layer of standard 3D convolution is appended to the result, to output a final rough three-dimensional model.

In some embodiments, the performing at least one instance of hierarchical encoding processing based on different spatial resolution levels and based on the first encoded feature and the second encoded feature, to obtain a first encoding processing result includes: obtaining an input model feature of a current encoding layer, an input model feature of a first encoding layer being the second encoded feature, and an input model feature of a non-first encoding layer being an output of a previous encoding layer; performing fusion processing on the first encoded feature and the input model feature of the current encoding layer to obtain a first fusion result, and downsampling the first fusion result to obtain an output of the current encoding layer, to complete hierarchical encoding processing of the current encoding layer; and continuing to perform hierarchical encoding processing of a next encoding layer until a last encoding layer, and using a first fusion result of the last encoding layer as an output of the last encoding layer, the output of the last encoding layer being the first encoding processing result.

For the process of the any instance of first encoding/decoding processing in the any current round, fusion processing is performed by using the at least one encoding layer. During fusion processing, input data of the encoding layer may include the input model feature and the first encoded feature. The input model feature of the first encoding layer is the second encoded feature determined based on the generation seed, and the input model feature of the non-first encoding layer is determined based on the output of the previous encoding layer.

Specifically, the computer device may dispose a feature fusion module at the encoding layer, perform feature fusion processing on the input model feature and the first encoded feature by using the feature fusion module of the encoding layer, to obtain the first fusion result, and further perform downsampling processing on the first fusion result, to obtain the output of the current encoding layer. Through downsampling processing, computing resources can be saved, and data processing efficiency of the computer device can be improved. When a plurality of encoding layers are included, the computer device performs hierarchical encoding processing of the next encoding layer until feature fusion processing of the last encoding layer is completed, to obtain the output of the last encoding layer, and determines the first fusion result outputted by the last encoding layer as the first encoding processing result.

In some embodiments, the feature fusion module may be a calculation module set based on a feature fusion algorithm. The feature fusion algorithm may include a residual network (ResNet), a feature pyramid network (FPN) (a target detection algorithm), and a feature fusion single shot multibox detector (FSSD) (an improved lightweight feature fusion algorithm).

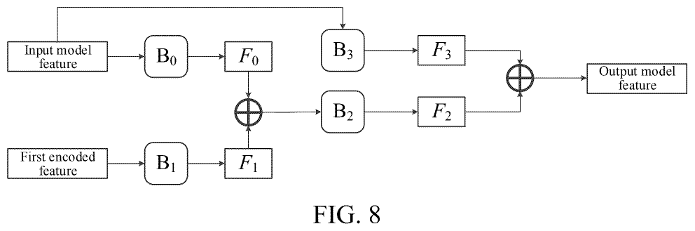

In some embodiments, the computer device may perform feature fusion processing based on the ResNet. FIG. 8 is a block flowchart of performing fusion processing based on the ResNet in a process of any instance of first encoding/decoding processing. Input data of the ResNet may include an input model feature

$${F}_{s}^{c}$$

and a first encoded feature

$${F}_{t}^{c} .$$

A three-dimensional convolution operation may be performed on the first encoded feature

$${F}_{t}^{c}$$

through a unit B₁, to obtain a three-dimensional model convolution operation result F₁ corresponding to the first encoded feature. A three-dimensional convolution operation may be performed on the input model feature

$${F}_{s}^{c}$$

through a unit B₀, to obtain a three-dimensional model convolution operation result F₀ corresponding to the input model feature. Further, the computer device may perform feature fusion on F₀ and F₁ to obtain an initial fusion result B₂ of F₁ and F₂, and perform a three-dimensional convolution operation on the input model feature through a unit B₃, to obtain a three-dimensional model convolution operation result F₃ corresponding to the input model feature. The computer device may fuse the initial fusion result B₂ and the three-dimensional model convolution operation result F₃ to obtain a first fusion result. The computer device may downsample the first fusion result to obtain an output model feature, that is, an output of the current encoding layer.

In some embodiments, the ResNet module relates to the following calculation process:

$${F}_{0} = {B}_{0} ( {F}_{s}^{c} ) = S i L U ( B N ( {CNN}_{3 D} ( {F}_{s}^{c} ) ) )$$

$${F}_{1} = {B}_{1} ( {F}_{t}^{c} ) = SiLU ( linear ( {F}_{t}^{c} ) )$$

$${F}_{2} = {B}_{2} ( {F}_{0} ⊕ {F}_{1} ) = Dropout ( SiLU ( B N ( {CNN}_{3 D} ( {F}_{0} ⊕ {F}_{1} ) ) ) )$$

$${F}_{3} = {B}_{3} ( {F}_{s}^{c} ) = SiLU ( B N ( {CNN}_{3 D} ( {F}_{s}^{c} ) ) )$$

$${F}_{out}^{0} = Sample ( {F}_{2} ⊕ {F}_{3} )$$

⊕ is a tensor addition operation following a tensor propagation mechanism. SiLU is the activation function. linear is a linear neural network. BN is batch normalization.

In the foregoing embodiment, the computer device may perform fusion processing on the input model feature and the first encoded feature by using the at least one encoding layer of the first subnetwork model, to obtain the first fusion result of the encoding layer, and further perform downsampling processing on the first fusion result to obtain the output of the current encoding layer. Through downsampling processing, computing resources can be saved, and the data processing efficiency of the computer device can be improved.

In some embodiments, the performing at least one instance of fusion processing based on the first encoding processing result and the first encoded feature, to obtain a first intermediate processing result includes: obtaining an input model feature in a current fusion process, an input model feature in a first fusion process being the first encoding processing result, and an input model feature in a non-first fusion process being an output of a previous instance of fusion processing; performing fusion processing on the first encoded feature and the input model feature in the current fusion process to obtain a second fusion result, to complete a current instance of fusion processing; and continuing to perform a next instance of fusion processing until a last instance of fusion processing is completed, and using a second fusion result of the last instance of fusion processing as the first intermediate processing result.

For the process of the any instance of first encoding/decoding processing in the any current round, fusion processing is performed by using at least one connection layer. When fusion processing is performed by using the connection layer, input data of the connection layer may include the input model feature and the first encoded feature. An input model feature of a first connection layer is the first encoding processing result. An input model feature of a non-first connection layer is determined based on an output of a previous connection layer obtained by performing fusion processing.

Specifically, the computer device may dispose a feature fusion module at the connection layer, and perform feature fusion processing on the input model feature and the first encoded feature by using the feature fusion module of the connection layer, to obtain the first intermediate processing result. When a plurality of connection layers are included, when completing a current instance of fusion processing of a current connection layer, the computer device performs fusion processing of a next connection layer until feature fusion of the last connection layer is completed, to obtain an output of fusion processing of the last connection layer, and uses the second fusion result outputted by the last connection layer as the first intermediate processing result. When performing fusion processing on the input model feature and the first encoded feature by using the feature fusion module of the connection layer, the computer device may not perform sampling processing the output of fusion processing, so that feature processing can be performed at a specific resolution, improving precision of feature processing.

In some embodiments, the feature fusion module disposed at the connection layer may use a same feature fusion algorithm as or different feature fusion algorithm from the feature fusion module disposed at the encoding layer. For example, the feature fusion module disposed at the connection layer is a calculation module set based on the ResNet.

In the foregoing embodiment, the computer device may perform fusion processing on the input model feature and the first encoded feature by using the at least one connection layer of the first subnetwork model, to obtain the second fusion result of the connection layer, and may not perform sampling processing on the second fusion result, so that feature processing can be performed at a specific resolution by using the connection layer, improving the precision of feature processing.

In some embodiments, the performing at least one instance of hierarchical decoding processing based on different spatial resolution levels and based on the first intermediate processing result and an output of each instance of hierarchical encoding processing, to obtain an output of the current instance of first encoding/decoding processing includes: obtaining an input model feature of a current decoding layer, an input model feature of a first decoding layer being the first intermediate processing result, and an input model feature of a non-first decoding layer including an output of a previous decoding layer and an output of an encoding layer corresponding to a same resolution; performing fusion processing on the first encoded feature and the input model feature of the current decoding layer to obtain a third fusion result, and upsampling the third fusion result to obtain an output of the current decoding layer, to complete hierarchical decoding of the current decoding layer; and continuing to perform hierarchical decoding processing of a next decoding layer until a last decoding layer, and using a third fusion result of the last decoding layer as an output of the last decoding layer, the output of the last decoding layer being the output of the current instance of first encoding/decoding processing.

For the process of the any instance of first encoding/decoding processing in the any current round, fusion processing is performed by using the at least one decoding layer. During fusion processing, input data of the decoding layer may include the input model feature and the first encoded feature. The input model feature of the first decoding layer is the first intermediate processing result, and the input model feature of the non-first decoding layer includes the output of the previous decoding layer and the output of the encoding layer corresponding to the same resolution.

Specifically, the computer device may dispose a feature fusion module at the decoding layer, perform feature fusion processing on the input model feature and the first encoded feature by using the feature fusion module of the decoding layer, to obtain the third fusion result, and further perform upsampling processing on the third fusion result to obtain the output of the current decoding layer. Through upsampling processing, the resolution can be increased, and the three-dimensional model generation precision can be improved. When a plurality of decoding layers are included, the computer device performs hierarchical decoding processing of the next decoding layer until feature fusion processing of the last decoding layer is completed, to obtain the output of the last decoding layer, and determines the third fusion result outputted by the last decoding layer as the output of the current instance of first encoding/decoding processing.

In some embodiments, the feature fusion module disposed at the decoding layer may use a same feature fusion algorithm as or different feature fusion algorithm from the feature fusion modules disposed at the encoding layer and an intermediate/connection layer. For example, the feature fusion module disposed at the decoding layer is a calculation module set based on the ResNet.

In the foregoing embodiment, the computer device may perform fusion processing on the input model feature and the first encoded feature by using the at least one decoding layer of the first subnetwork model, to obtain the third fusion result of the decoding layer, and further perform upsampling processing on the third fusion result to obtain the output of the current decoding layer. Through upsampling processing, the resolution can be increased, and the three-dimensional model generation precision can be improved.

In some embodiments, the performing at least one round of second processing based on the second generation intensity and the rough three-dimensional model by using the second subnetwork model, to obtain a three-dimensional object model that satisfies a preset resolution condition and that belongs to the object category includes: determining a second quantity of times based on the second generation intensity, performing second processing for the second quantity of times by using the second subnetwork model, and obtaining the three-dimensional object model based on an output of a last instance of second processing.

The second quantity of times is a determined quantity of times of performing second processing by using the first subnetwork model. Usually, a larger value of the second quantity of times indicates a larger quantity of times of performing second processing by using the second subnetwork model and better quality and higher precision of the obtained three-dimensional object model.

Specifically, the computer device determines, based on the second generation intensity, the second quantity of times of performing second processing, to perform iterative processing on the second subnetwork model based on the second quantity of times, and determine the output of the last instance of second processing as the three-dimensional object model.

In some embodiments, the computer device determines, based on the second generation intensity, that the second quantity of times is 3. In this case, three instances of second processing need to be performed on the first subnetwork model, including the first instance of second processing, the second instance of second processing, and the third instance of second processing. Each instance of second processing includes at least two instances of second encoding/decoding processing. The computer device may obtain the three-dimensional object model based on an output of the third instance of second processing.

In some embodiments, the second generation intensity may be specifically a value. The computer device may directly use the second generation intensity as the second quantity of times, or obtain the second quantity of times by performing a mathematical operation on the second generation intensity. The mathematical operation performed herein may be, for example, doubling processing or adding a preset value. The preset value may be, for example, 1, 2, or another value.

In one embodiment, for example, the second generation intensity is 1, and the computer device may add 1 to 1 to obtain a second quantity of times of 2. When the second quantity of times is 2, the second subnetwork model needs to perform two instances of second processing, including the first instance of first processing and the second instance of first processing, each instance of first processing including at least two instances of first encoding/decoding processing.

In some embodiments, the computer device may perform format conversion processing on the obtained output of the last instance of second processing to obtain a triangular mesh model that satisfies the high-resolution condition and that belongs to the object category. The computer device may determine the obtained triangular mesh model as the three-dimensional object model.

In some embodiments, the obtaining the three-dimensional object model based on an output of a last instance of second processing includes: performing three-dimensional convolution processing on the output of the last instance of second processing to obtain an output of the second subnetwork model; and converting the output of the second subnetwork model into the triangular mesh model, to obtain the three-dimensional object model belonging to the object category, the three-dimensional object model satisfying the preset resolution condition.

Specifically, the computer device may perform three-dimensional convolution processing on the output of the last instance of second processing, to transform a dimension of a feature vector outputted through the last instance of second processing, to obtain the output of the second subnetwork model. Further, the computer device may convert the output of the second subnetwork model into the triangular mesh model by using a surface rendering algorithm, for example, a contour connection method, a cube algorithm, a cube decomposition algorithm, and a marching cube algorithm, to obtain, based on the triangular mesh model, a final three-dimensional object model satisfying the preset resolution condition. When performing convolution processing on the output of second processing, the computer device may perform processing based on three-dimensional convolution, depthwise separable convolution, or the like, or by using another deep learning operator instead.

In the foregoing embodiment, the computer device performs three-dimensional convolution processing on the output of the last instance of second processing to obtain the output of the second subnetwork model, converts the output of the second subnetwork model into the triangular mesh model, and obtains the three-dimensional object model based on the three-dimensional mesh model, helping the user better observe and understand a specific object concept.

In some embodiments, each round of second processing includes at least two instances of second encoding/decoding processing, and a process of each instance of second encoding/decoding processing in any current round includes the following operations: obtaining a third encoded feature in the current instance of second encoding/decoding processing, third encoded features in instances of second encoding/decoding processing in the current round being the same and determined based on a round number corresponding to the current round; obtaining a fourth encoded feature in the current instance of second encoding/decoding processing, a fourth encoded feature in a first instance of second encoding/decoding processing in a first round being determined based on the rough three-dimensional model, and a fourth encoded feature in a non-first instance of second encoding/decoding processing in a non-first round being an output of a previous instance of second encoding/decoding processing; performing at least one instance of hierarchical encoding processing based on different spatial resolution levels and based on the third encoded feature and the fourth encoded feature, to obtain a second encoding processing result; performing at least one instance of fusion processing based on the second encoding processing result and the third encoded feature, to obtain a second intermediate processing result; and performing at least one instance of hierarchical decoding processing based on different spatial resolution levels and based on the second intermediate processing result and an output of each instance of hierarchical encoding processing, to obtain an output of the current instance of second encoding/decoding processing.

The second subnetwork model may include at least one encoding layer, and hierarchical encoding processing is performing encoding processing on each encoding layer. There is a corresponding output spatial resolution level for each encoding layer. The output spatial resolution level is a voxel spatial resolution set for each encoding layer. Voxel spatial resolutions for different encoding layers may be different or the same. The voxel spatial resolutions may be adaptively set with reference to a requirement for the three-dimensional model generation precision, the computing resource of the computer device, and the like.

The second subnetwork model may further include at least one decoding layer, and hierarchical decoding processing is performing decoding layer processing on each decoding layer. There is a corresponding spatial resolution for a different decoding layer. Voxel spatial resolutions for different decoding layers may be different or the same.

At least one connection layer may be further disposed between the encoding layer and the decoding layer of the second subnetwork model, and each connection layer may be configured for connecting the encoding layer to the decoding layer. The second intermediate processing result is determined based on a fusion result obtained by the connection layer by performing fusion processing on the second encoding processing result and the third encoded feature.

Specifically, the computer device may determine the second quantity of times based on the second generation intensity, and set, based on the second quantity of times, a quantity of rounds of second processing to be performed. In the process of the any instance of second encoding/decoding processing in the current round, the computer device may determine the third encoded feature based on the round number corresponding to the current round. For the fourth encoded feature, if the current round is the first round, and the fourth encoded feature is for the first instance of second encoding/decoding processing in the first round, the computer device may determine the fourth encoded feature based on the rough three-dimensional model; or if the fourth encoded feature is not for the first instance of second encoding/decoding processing in the first round, the computer device may determine the fourth encoded feature based on the output of the previous instance of second encoding/decoding processing.

Further, for the process of the any instance of second encoding/decoding processing in the current round, the computer device may perform hierarchical encoding processing on the third encoded feature and the fourth encoded feature by using the at least one encoding layer that is in the second subnetwork model and for which the spatial resolution level is set, to obtain the second encoding processing result. Based on obtaining the second encoding processing result, the computer device may perform the at least one instance of feature fusion processing on the third encoded feature and the second encoding processing result by using the connection layer in the second subnetwork model, to obtain the second intermediate processing result.

Further, the computer device may perform hierarchical decoding processing on the second intermediate processing result and the output of each instance of hierarchical encoding processing by using the at least one decoding layer that is in the second subnetwork model and for which the spatial resolution level is set, to obtain the output of the current instance of second encoding/decoding processing. The spatial resolution level for the encoding layer may match the resolution level for the decoding layer.

In some embodiments, the voxel spatial resolution corresponding to the encoding layer may decrease as the layer increases. The second subnetwork model may include a preset quantity of encoding layers, for example, five encoding layers. The voxel spatial resolutions may be set to 128³, 64³, 32³, 16³, 8³ based on a sequence of performing hierarchical encoding. The voxel spatial resolution corresponding to the decoding layer increases as the layer increases. The second subnetwork model may include a preset quantity of decoding layers, for example, five decoding layers. The voxel spatial resolutions may be set to 8³, 16³, 32³, 64³, 128³ based on a sequence of performing hierarchical decoding. The voxel space resolution of the second subnetwork model may be set to be higher than the voxel space resolution of the first subnetwork model, so that a more accurate three-dimensional object model can be obtained.

In some embodiments, determining operations for the fourth encoded feature in the first instance of second encoding/decoding processing in the first round include: upsampling the rough three-dimensional model to obtain a second tensor; using an element that is in the second tensor and whose value is greater than a preset value as a first element, and using an element in the second tensor other than the first element as a second element; replacing a value of the first element with a randomly generated number to obtain an updated second tensor; and performing three-dimensional convolution processing on the updated second tensor to obtain the fourth encoded feature located within the three-dimensional space, a second element in the updated second tensor not participating in three-dimensional convolution processing.

The second tensor is configured for representing a shape of the rough three-dimensional model in the multi-dimensional space. The preset value is a preset value for determining each element in the second tensor, to determine whether each element participates in three-dimensional convolution processing. The random number is a Gaussian parameter, for example, a Gaussian floating-point number, generated based on a random seed. The random number may range from 0 to 1.

Specifically, for determining of the fourth encoded feature in the first instance of second encoding/decoding processing in the first round, the computer device may perform upsampling by using the rough three-dimensional model, to obtain the second tensor, use the element that is in the second tensor and whose value is greater than the preset value as the first element, use the element in the second tensor other than the first element as the second element, replace the value of the first element with the randomly generated number to obtain the updated second tensor, and perform three-dimensional convolution processing on the updated second tensor to obtain the fourth encoded feature located within the three-dimensional space.

In some embodiments, the computer device may upsample the rough three-dimensional model by using the following formula:

$${X}_{f}^{0} = Rand ( UpSample ( {M}_{out}^{c} ) )$$

UpSample is an upsampling operation in a three-dimensional Euclidean space. Rand indicates that the following operation is performed on all elements of the tensor:

$$Rand ( x ) = \{ \begin{matrix}g r ( {s}_{c} ) & x > 0 \\ - 1 & x \leq 0\end{matrix}$$

gr(s_{c}) represents a random Gaussian floating-point number that is generated based on a random seed s_{c} and that is 0 to 1. −1 represents that no operation is performed on a corresponding region. When an element in the second tensor is greater than 0, the computer device may use the element as the first element, and replace the first element based on the random Gaussian floating-point number. Alternatively, the computer device may determine an element less than or equal to 0 in the second tensor as the second element, and replace the second element with −1. After completing replacement processing on the element in the second tensor, the computer device may calculate the fourth encoded feature based on the random Gaussian floating-point number in the second tensor by using a same operation process as calculation of the second encoded feature.

In this embodiment, the computer device may perform upsampling by using the rough three-dimensional model, to obtain the second tensor, use the element that is in the second tensor and whose value is greater than the preset value as the first element, use the element in the second tensor other than the first element as the second element, and replace the value of the first element with the randomly generated number, assign Gaussian noise to the first element for encoding. Therefore, computing resources can be saved.

In some embodiments, the performing at least one instance of hierarchical encoding processing based on different spatial resolution levels and based on the third encoded feature and the fourth encoded feature, to obtain a second encoding processing result includes: obtaining an input model feature of a current encoding layer, an input model feature of a first encoding layer being the fourth encoded feature, and an input model feature of a non-first encoding layer being an output of a previous encoding layer; performing fusion processing on the third encoded feature and the input model feature of the current encoding layer to obtain a fourth fusion result, and downsampling the fourth fusion result to obtain an output of the current encoding layer, to complete hierarchical encoding processing of the current encoding layer; and continuing to perform hierarchical encoding processing of a next encoding layer until a last encoding layer, and using a fourth fusion result of the last encoding layer as an output of the last encoding layer, the output of the last encoding layer being the second encoding processing result.

For a process of any instance of second encoding/decoding processing in any current round, fusion processing is performed by using the at least one encoding layer. During fusion processing, input data of the encoding layer may include an input model feature and the third encoded feature. The input model feature of the first encoding layer is the fourth encoded feature determined based on the rough three-dimensional model, and the input model feature of the non-first encoding layer is determined based on the output of the previous encoding layer.

Specifically, the computer device may dispose a feature fusion module at the encoding layer, perform feature fusion processing on the input model feature and the third encoded feature by using the feature fusion module of the encoding layer, to obtain the fourth fusion result, and further perform downsampling processing on the fourth fusion result, to obtain the output of the current encoding layer. Through downsampling processing, computing resources can be saved, and the data processing efficiency of the computer device can be improved. When a plurality of encoding layers are included, the computer device performs hierarchical encoding processing of the next encoding layer until feature fusion processing of the last encoding layer is completed, to obtain the output of the last encoding layer, and determines the fourth fusion result outputted by the last encoding layer as the second encoding processing result.

In the foregoing embodiment, the computer device may perform fusion processing on the input model feature and the third encoded feature by using the at least one encoding layer of the second subnetwork model, to obtain the fourth fusion result of the encoding layer, and further perform downsampling processing on the fourth fusion result to obtain the output of the current encoding layer. Through downsampling processing, computing resources can be saved, and the data processing efficiency of the computer device can be improved.

In some embodiments, the performing at least one instance of fusion processing based on the second encoding processing result and the third encoded feature, to obtain a second intermediate processing result includes: obtaining an input model feature in a current fusion process, an input model feature in a first fusion process being the second encoding processing result, and an input model feature in a non-first fusion process being an output of a previous instance of fusion processing; performing fusion processing on the third encoded feature and the input model feature in the current fusion process to obtain a fifth fusion result, to complete a current instance of fusion processing; and continuing to perform a next instance of fusion processing until a last instance of fusion processing is completed, and using a fifth fusion result of the last instance of fusion processing as the second intermediate processing result.

For a process of any instance of second encoding/decoding processing in any current round, fusion processing is performed by using at least one connection layer. When fusion processing is performed by using the connection layer, input data of the connection layer may include an input model feature and a third encoded feature. An input model feature of a first connection layer is the second encoding processing result. An input model feature of a non-first connection layer is determined based on an output of a previous connection layer obtained by performing fusion processing.

Specifically, the computer device may dispose a feature fusion module at the connection layer, and perform feature fusion processing on the input model feature and the third encoded feature by using the feature fusion module of the connection layer, to obtain the second intermediate processing result. When a plurality of connection layers are included, when completing a current instance of fusion processing of a current connection layer, the computer device performs fusion processing of a next connection layer until feature fusion of the last connection layer is completed, to obtain an output of fusion processing of the last connection layer, and uses the fifth fusion result outputted by the last connection layer as the second intermediate processing result. When performing fusion processing on the input model feature and the third encoded feature by using the feature fusion module of the connection layer, the computer device may not perform sampling processing the output of fusion processing, so that feature processing can be performed at a specific resolution, improving precision of feature processing.

In the foregoing embodiment, the computer device may perform fusion processing on the input model feature and the third encoded feature by using the at least one connection layer of the second subnetwork model, to obtain the fifth fusion result of the connection layer, and may not perform sampling processing on the fifth fusion result, so that feature processing can be performed at a specific resolution, improving the precision of feature processing.

In some embodiments, the performing at least one instance of hierarchical decoding processing based on different spatial resolution levels and based on the second intermediate processing result and an output of each instance of hierarchical encoding processing, to obtain an output of the current instance of second encoding/decoding processing includes: obtaining an input model feature of a current decoding layer, an input model feature of a first decoding layer being the second intermediate processing result, and an input model feature of a non-first decoding layer including an output of a previous decoding layer and an output of an encoding layer corresponding to a same resolution; performing fusion processing on the third encoded feature and the input model feature of the current decoding layer to obtain a sixth fusion result, and upsampling the sixth fusion result to obtain an output of the current decoding layer, to complete hierarchical decoding of the current decoding layer; and continuing to perform hierarchical decoding processing of a next decoding layer until a last decoding layer, and using a sixth fusion result of the last decoding layer as an output of the last decoding layer, the output of the last decoding layer being the output of the current instance of second encoding/decoding processing.

For the process of the any instance of second encoding/decoding processing in the any current round, fusion processing is performed by using the at least one decoding layer. During fusion processing, input data of the decoding layer may include the input model feature and the third encoded feature. The input model feature of the first decoding layer is the second intermediate processing result, and the input model feature of the non-first decoding layer includes the output of the previous decoding layer and the output of the encoding layer corresponding to the same resolution.

Specifically, the computer device may dispose a feature fusion module at the decoding layer, perform feature fusion processing on the input model feature and the third encoded feature by using the feature fusion module of the decoding layer, to obtain the sixth fusion result, and further perform upsampling processing on the sixth fusion result to obtain the output of the current decoding layer. Through upsampling processing, the resolution can be increased, and the three-dimensional model generation precision can be improved. When a plurality of decoding layers are included, the computer device performs hierarchical decoding processing of the next decoding layer until feature fusion processing of the last decoding layer is completed, to obtain the output of the last decoding layer, and determines the sixth fusion result outputted by the last decoding layer as the output of the current instance of second encoding/decoding processing.

In the foregoing embodiment, the computer device may perform fusion processing on the input model feature and the third encoded feature by using the at least one decoding layer of the second subnetwork model, to obtain the sixth fusion result of the decoding layer, and further perform upsampling processing on the sixth fusion result to obtain the output of the current decoding layer. Through upsampling processing, the resolution can be increased, and the three-dimensional model generation precision can be improved.

In some embodiments, training operations for the first subnetwork model include: obtaining a plurality of three-dimensional sample models belonging to the object category, and normalizing each three-dimensional sample model to a preset vector space to obtain a normalized sample; obtaining, through conversion based on the normalized sample, first training data corresponding to a first resolution, and adding noise to the first training data to obtain a first input sample; determining a first training iteration count, and determining, based on the first training iteration count, a first intensity sample in any round of first subnetwork model training process; and performing first iterative training on a first subnetwork model in a candidate network model to be trained by using the first training data, the first input sample, and the first intensity sample, to obtain a trained first subnetwork model at the end of training.

The three-dimensional sample model is a three-dimensional model needing to be used in a model training phase, and may be specifically object models of multiple categories. The three-dimensional sample model may specifically include a plurality of three-dimensional parameters for describing three-dimensional attributes of an object, such as a vertex and a connection line. There may be a plurality of corresponding three-dimensional sample models for each object category.

The preset vector space is a Euclidean space, and each three-dimensional sample model is normalized to the Euclidean space to obtain the normalized sample. The first training data of the first resolution is obtained by converting the normalized sample.

Specifically, for each object category, the computer device may obtain a plurality of three-dimensional sample models of each object category, and normalize any three-dimensional sample model to the Euclidean space to obtain a normalized triangular mesh. The computer device may convert the normalized triangular mesh into first training data of the first resolution. Further, the computer device may add various types of noise to the first training data to obtain the first input sample. The computer device may further perform first iterative training on the first subnetwork model in the candidate network model based on the determined first intensity sample, first training data, and first input sample, and end training when a training stopping condition is reached, to obtain the trained first subnetwork model. The training stopping condition may be specifically that a preset iteration count is reached, an error between a predicted value and a target value is less than an error threshold, training duration reaches preset duration, or the like. This is not limited in this embodiment of the present disclosure.

In each training process, at least two iterations may be performed on the network model, that is, at least two instances of encoding/decoding may be performed, so that model robustness can be effectively improved.

In some embodiments, the candidate network model may be a generative model, for example, a diffusion model or a variational autoencoder model.

In some embodiments, the first resolution and a format of the first training data may be adaptively adjusted based on an actual three-dimensional model generation requirement and scenario, and the like. For example, the first resolution may be 128³ or 64³. The first training data may be data represented based on a signed distance field, or may be data represented based on a voxel space.

In some embodiments, to obtain the first training data of the first resolution, the computer device may convert the normalized triangular mesh into an implicit signed distance field with a resolution of 128³ by using a Mesh2SDF (mesh distance field) algorithm.

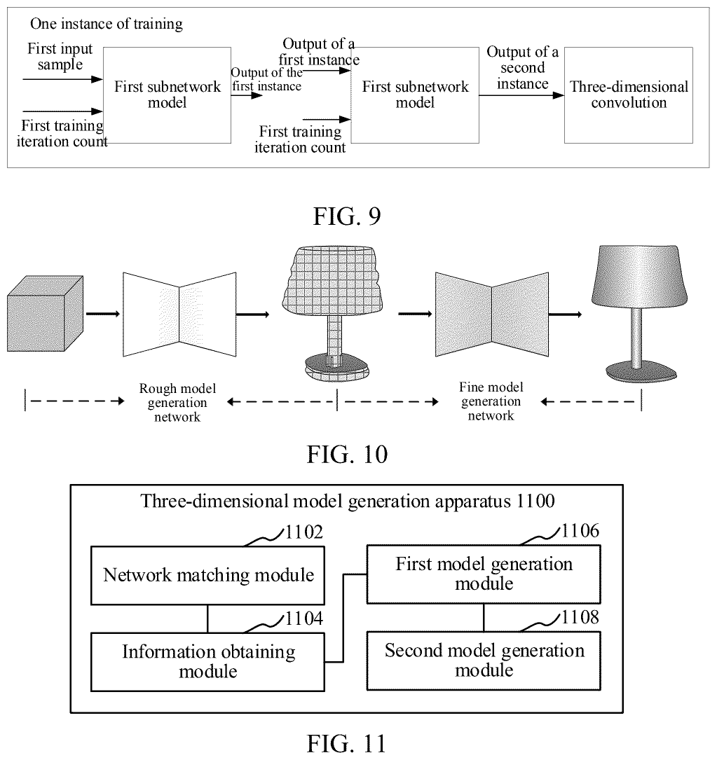

In some embodiments, FIG. 9 is a block flowchart for describing one training process of training the first subnetwork model.

The computer device obtains the first training data, and adds various types of noise to the first training data to obtain the first input sample. Further, the computer device may randomly select a natural number, use the selected natural number as the first training iteration count, and perform a first instance of iterative training on the candidate network model by using the first input sample and the first training iteration count as input data and using the first training data as a label, to obtain an output of the first instance of iterative training. Further, the computer device may input the output of the first instance of iterative training and the first training iteration count to the network model, to perform a second instance of iterative training.

In some embodiments, training operations for the second subnetwork model include: obtaining a plurality of three-dimensional sample models belonging to the object category, and normalizing each three-dimensional sample model to the preset vector space to obtain a normalized sample; obtaining, through conversion based on the normalized sample, second training data corresponding to a second resolution, the second resolution being greater than the first resolution, and the first resolution being a resolution of the first training data for training the first subnetwork model; adding noise to the second training data to obtain a second input sample; determining a second training iteration count, and determining, based on the second training iteration count, a second intensity sample in any round of second subnetwork model training process; and performing second iterative training on a second subnetwork model in the candidate network model by using the second training data, the second input sample, and the second intensity sample, to obtain a trained second subnetwork model at the end of training.

Each three-dimensional sample model is normalized to the Euclidean space to obtain the normalized sample. The second training data of the second resolution is obtained by converting the normalized sample.

In some embodiments, to obtain the second training data of the second resolution, conversion from the SDF with the solution of 128³ to the voxel space V with the resolution of 64³ may be performed. In this case, each voxel Vᵢ in the voxel space has eight SDF values, represented as

$$\{ {d}_{0}^{i} , {d}_{1}^{i} , ⋯ , {d}_{7}^{i} \} ,$$

and a determining policy for whether Vᵢ is located on a triangular mesh surface is as follows: If

$$min \{ {d}_{0}^{i} , {d}_{1}^{i} , ⋯ , {d}_{7}^{i} \} < 0.033 ,$$

it is considered that Vᵢ is located on the corresponding triangular mesh surface, and the voxel is mapped to 1; or if

$$min \{ {d}_{0}^{i} , {d}_{1}^{i} , ⋯ , {d}_{7}^{i} \}$$

is not less than 0.033, it is considered that Vᵢ does not belong to the triangular mesh surface, and the voxel is mapped to 0.

Specifically, for each object category, the computer device may obtain a plurality of three-dimensional sample models of each object category, and normalize any three-dimensional sample model to the Euclidean space to obtain a normalized triangular mesh. The computer device may convert the normalized triangular mesh into second training data of the second resolution. Further, the computer device may add various types of noise to the second training data to obtain the second input sample. The computer device may further perform second iterative training on the second subnetwork model in the candidate network model based on the determined second intensity sample, second training data, and second input sample, and end training when a training stopping condition is reached, to obtain the trained second subnetwork model. The training stopping condition may be specifically that a preset iteration count is reached, an error between a predicted value and a target value is less than an error threshold, training duration reaches preset duration, or the like. This is not limited in this embodiment of the present disclosure.

In some embodiments, a resolution and a format of the second training data may be adaptively adjusted based on the actual three-dimensional model generation requirement and scenario, and the like. For example, the second resolution may be 128³ or 64³ as long as the second resolution is lower than the first resolution. The second training data may be data represented based on the signed distance field, or may be data represented based on the voxel space.

In the foregoing embodiment, the computer device may obtain the plurality of three-dimensional sample models belonging to the object category, and convert the plurality of three-dimensional sample models obtained, to obtain the second training data corresponding to the second resolution, thereby performing second iterative training on the second subnetwork model in the candidate network model based on the second training data, the second input sample, and the second intensity sample. This can improve the three-dimensional model generation quality, and significantly improves a success rate of three-dimensional model generation.

In an embodiment, the present disclosure further provides an application scenario. The foregoing three-dimensional model generation method is applied to the application scenario. Specifically, an application of the three-dimensional model generation method to the application scenario is as follows.

FIG. 10 is a diagram of an architecture of a three-dimensional model generation network for the three-dimensional model generation method according to the present disclosure. It can be learned from FIG. 10 that the present disclosure relates to two networks in total: a rough model generation network and a fine model generation network. The rough model generation network is the first subnetwork model, and the fine model generation network is the second subnetwork model. The computer device may determine the rough three-dimensional model based on the rough model generation network, and optimize the rough three-dimensional model based on the fine model generation network, to obtain a high-quality three-dimensional object model.

The rough model generation network and the fine model generation network are pre-trained models. In a training phase, the computer device may collect a large quantity of three-dimensional models, and perform data labeling in different categories to construct training data for multiple categories of objects; and then train an independent three-dimensional model generation network for each category of object. A training process is divided into two phases: rough model generation and fine model generation. The generation networks in both phases may be designed and trained based on a diffusion model, to improve three-dimensional model generation quality. Training for three-dimensional model generation with a diffusion generative model not only improves the three-dimensional model generation quality, but also significantly improves the success rate of three-dimensional model generation. The generation networks in the two phases may be trained at the same time. Specifically, a loss function used in the training process is:

$${L}_{{x}_{0}} = {E}_{ε ∼ {G}_{1} ( 0 , I ) , t ∼ {G}_{2} ( 0 , 1 )} {‖ f ( {x}_{t} , \tilde{{x}_{0}} , t ) - {x}_{0} ‖}^{2}$$

$${x}_{t} = \sqrt{β ( t )} {x}_{0} + \sqrt{1 - β ( t )} ε$$

G₁ is a Gaussian distribution. G₂ is a uniform distribution. β(t)=e^{-10t}^{²}¹⁰^{^{−4}}. f corresponds to the rough model generation network and the fine model generation network. During rough model generation training, x₀ corresponds to the voxel space with the resolution of 64³. During fine model generation training, x₀ corresponds the signed distance field with the resolution of 128³. t is a set training iteration count. [symbol] is a previous prediction result in a training process. xₜ is a noised input sample. In a model training process, there is a 50% probability of assigning f(xₜ, 0, t) to [symbol] and a remaining 50% probability of assigning a tensor whose shape is the same as that of x₀ but whose values of elements are all 0 to [symbol] .

In an application phase, matching is first performed to find a three-dimensional model generation network of a most appropriate category for a modeling text inputted by the user, and then the three-dimensional object model is generated based on the corresponding three-dimensional model generation network, and is fed back to the user. Compared with a completely random three-dimensional model generation manner, the computer device may receive a text prompt, and obtain a three-dimensional model of a same category based on the text prompt, improving the quality and the success rate of three-dimensional model generation.

When generating the three-dimensional object model based on the three-dimensional model generation network, the computer device may determine the rough three-dimensional model based on the rough model generation network in the three-dimensional model generation network. Specifically, when the rough three-dimensional model is generated, the at least one round of first processing may be performed based on the first generation intensity and the generation seed by using the rough model generation network, to obtain the rough three-dimensional model. When the three-dimensional object model is generated, the at least one round of second processing may be performed based on the second generation intensity and the rough three-dimensional model by using the fine model generation network, to obtain the three-dimensional object model that satisfies the preset resolution condition and that belongs to the object category. According to such a three-dimensional object model generation method, a new object category generation task can be easily supported, and a model generation network of each category can be separately maintained and updated, enhancing system maintainability.

The three-dimensional model generation method provided in the present disclosure may be applied to a plurality of scenarios. For example, in a game related to a three-dimensional model, a game producer can be helped to generate a wanted three-dimensional model as a game asset, and create more complex characters, scenes, and special effects based on the three-dimensional model, thereby increasing a game development speed and improving game production efficiency; and a player can be helped to generate a three-dimensional model of interest and import the three-dimensional model into a game for use, thereby improving a sense of participation of the user. In product design and manufacture, a designer can be helped to rapidly generate a large quantity of three-dimensional models and perform testing and modification based on the generated models, and then these models may be used to guide a production process, for example, manufacture a physical product through 3D printing. In virtual reality and augmented reality, a large quantity of three-dimensional models can be rapidly generated to enrich virtual world scenes, thereby creating more vivid virtual reality (VR) and augmented reality (AR) experience. In education and training, a three-dimensional model of an object in which a learner is interested may be generated, to help the learner better observe and understand a specific object concept, thereby improving the pleasure of learning.

Although the operations in the flowchart in each of the foregoing embodiments are sequentially presented according to indications of arrowheads, these operations are not necessarily performed according to sequences indicated by the arrowheads. Unless otherwise explicitly specified in the present disclosure, execution of the operations is not strictly limited, and the operations may be performed in other sequences. Moreover, at least a part of the operations in each of the foregoing embodiments may include a plurality of operations or a plurality of stages. The operations or stages are not necessarily performed at the same moment but may be performed at different moments. The operations or stages are not necessarily performed in sequence, but may be performed alternately with other operations or at least a part of operations or stages of other operations.

Based on a same inventive concept, an embodiment of the present disclosure further provides a three-dimensional model generation apparatus for implementing the foregoing three-dimensional model generation method. An embodiment provided by the apparatus for resolving the problem is similar to the embodiment described in the foregoing method. Therefore, for definition of one or more embodiments of the three-dimensional model generation apparatus provided below, refer to the foregoing definition of the three-dimensional model generation method. Details are not described herein again.

In an exemplary embodiment, as shown in FIG. 11, a three-dimensional model generation apparatus 1100 is provided, including a network matching module 1102, an information obtaining module 1104, a first model generation module 1106, and a second model generation module 1108.

The network matching module 1102 is configured to obtain prompt information describing an object category, and determine a target network model matching the object category indicated by the prompt information, the target network model including a first subnetwork model and a second subnetwork model.

The information obtaining module 1104 is configured to obtain a first generation intensity, a second generation intensity, and a generation seed.

The first model generation module 1106 is configured to perform at least one round of first processing based on the first generation intensity and the generation seed by using the first subnetwork model, to obtain a rough three-dimensional model. Each round of first processing includes at least one instance of first encoding/decoding processing.

The second model generation module 1108 is configured to perform at least one round of second processing based on the second generation intensity and the rough three-dimensional model by using the second subnetwork model, to obtain a three-dimensional object model that satisfies a preset resolution condition and that belongs to the object category. Each round of second processing includes at least one instance of second encoding/decoding processing.

In an embodiment, the network matching module 1102 is further configured to: determine the object category indicated by the prompt information; and obtain the target network model matching the object category from a network model pool, the network model pool including a plurality of trained network models for generating three-dimensional object models of multiple categories, and the target network model being configured for generating a three-dimensional object model belonging to the object category indicated by the prompt information.

In an embodiment, the network matching module 1102 includes a category determining module. The category determining module is configured to: obtain a feature vector of each of a plurality of preset object category names to obtain a first feature set; perform vectorized representation on the prompt information to determine at least one feature vector related to the prompt information, to obtain a second feature set; calculate a similarity between each feature vector in the second feature set and each feature vector in the first feature set; and determine an object category to which a target feature vector belongs as the object category indicated by the prompt information, the object category satisfying a preset similarity condition, the target feature vector being in the in the first feature set and corresponding to a maximum similarity.

In an embodiment, the network matching module 1102 further includes a feature set determining module. The feature set determining module is configured to: perform word segmentation processing on the prompt information to obtain a plurality of word units in the prompt information; and extract a feature vector of the prompt information and a feature vector of each word unit to obtain the second feature set.

In an embodiment, the first model generation module 1106 is further configured to determine a first quantity of times based on the first generation intensity, perform first processing for the first quantity of times by using the first subnetwork model, and obtain the rough three-dimensional model based on an output of a last instance of first processing. Each round of first processing includes at least two instances of first encoding/decoding processing. A process of any instance of first encoding/decoding processing in any current round includes the following operations: obtaining a first encoded feature in the current instance of first encoding/decoding processing, first encoded features in instances of first encoding/decoding processing in the current round being the same and determined based on a round number corresponding to the current round; obtaining a second encoded feature in the current instance of first encoding/decoding processing, a second encoded feature in a first instance of first encoding/decoding processing in a first round being determined based on the generation seed, and a second encoded feature in a non-first instance of first encoding/decoding processing in a non-first round being an output of a previous instance of first encoding/decoding processing; performing at least one instance of hierarchical encoding processing based on different spatial resolution levels and based on the first encoded feature and the second encoded feature, to obtain a first encoding processing result; performing at least one instance of fusion processing based on the first encoding processing result and the first encoded feature, to obtain a first intermediate processing result; and performing at least one instance of hierarchical decoding processing based on different spatial resolution levels and based on the first intermediate processing result and an output of each instance of hierarchical encoding processing, to obtain an output of the current instance of first encoding/decoding processing.

In an embodiment, the three-dimensional model generation apparatus further includes a first encoded feature determining module. The first encoded feature determining module is configured to: determine a first value to be encoded in the current round based on the round number of the current round; expand the first value into a feature vector of a preset dimension; and perform at least one linear transformation on the feature vector of the preset dimension to obtain the first encoded feature.

In an embodiment, the three-dimensional model generation apparatus further includes a second encoded feature determining module. The second encoded feature determining module is configured to: generate a first tensor of a preset shape based on the generation seed by using a Gaussian function; and perform three-dimensional convolution processing on the first tensor of the preset shape to obtain the second encoded feature located within a three-dimensional space.

In an embodiment, the first model generation module 1106 is further configured to: obtain an input model feature of a current encoding layer, an input model feature of a first encoding layer being the second encoded feature, and an input model feature of a non-first encoding layer being an output of a previous encoding layer; perform fusion processing on the first encoded feature and the input model feature of the current encoding layer to obtain a first fusion result, and downsample the first fusion result to obtain an output of the current encoding layer, to complete hierarchical encoding processing of the current encoding layer; and continue to perform hierarchical encoding processing of a next encoding layer until a last encoding layer, and use a first fusion result of the last encoding layer as an output of the last encoding layer, the output of the last encoding layer being the first encoding processing result.

In an embodiment, the first model generation module 1106 is further configured to: obtain an input model feature in a current fusion process, an input model feature in a first fusion process being the first encoding processing result, and an input model feature in a non-first fusion process being an output of a previous instance of fusion processing; perform fusion processing on the first encoded feature and the input model feature in the current fusion process to obtain a second fusion result, to complete a current instance of fusion processing; and continue to perform a next instance of fusion processing until a last instance of fusion processing is completed, and use a second fusion result of the last instance of fusion processing as the first intermediate processing result.

In an embodiment, the first model generation module 1106 is further configured to: obtain an input model feature of a current decoding layer, an input model feature of a first decoding layer being the first intermediate processing result, and an input model feature of a non-first decoding layer including an output of a previous decoding layer and an output of an encoding layer corresponding to a same resolution; perform fusion processing on the first encoded feature and the input model feature of the current decoding layer to obtain a third fusion result, and upsample the third fusion result to obtain an output of the current decoding layer, to complete hierarchical decoding of the current decoding layer; and continue to perform hierarchical decoding processing of a next decoding layer until a last decoding layer, and use a third fusion result of the last decoding layer as an output of the last decoding layer, the output of the last decoding layer being the output of the current instance of first encoding/decoding processing.

In an embodiment, the second model generation module 1108 is further configured to determine a second quantity of times based on the second generation intensity, perform second processing for the second quantity of times by using the second subnetwork model, and obtain the three-dimensional object model based on an output of a last instance of second processing. Each round of second processing includes at least two instances of second encoding/decoding processing. A process of each instance of second encoding/decoding processing in any current round includes the following operations: obtaining a third encoded feature in the current instance of second encoding/decoding processing, third encoded features in instances of second encoding/decoding processing in the current round being the same and determined based on a round number corresponding to the current round; obtaining a fourth encoded feature in the current instance of second encoding/decoding processing, a fourth encoded feature in a first instance of second encoding/decoding processing in a first round being determined based on the rough three-dimensional model, and a fourth encoded feature in a non-first instance of second encoding/decoding processing in a non-first round being an output of a previous instance of second encoding/decoding processing; performing at least one instance of hierarchical encoding processing based on different spatial resolution levels and based on the third encoded feature and the fourth encoded feature, to obtain a second encoding processing result; performing at least one instance of fusion processing based on the second encoding processing result and the third encoded feature, to obtain a second intermediate processing result; and performing at least one instance of hierarchical decoding processing based on different spatial resolution levels and based on the second intermediate processing result and an output of each instance of hierarchical encoding processing, to obtain an output of the current instance of second encoding/decoding processing.

In an embodiment, the three-dimensional model generation apparatus further includes a fourth encoded feature determining module. The fourth encoded feature determining module is configured to: upsample the rough three-dimensional model to obtain a second tensor; use an element that is in the second tensor and whose value is greater than a preset value as a first element, and use an element in the second tensor other than the first element as a second element; replace a value of the first element with a randomly generated number to obtain an updated second tensor; and perform three-dimensional convolution processing on the updated second tensor to obtain the fourth encoded feature located within the three-dimensional space, a second element in the updated second tensor not participating in three-dimensional convolution processing.

In an embodiment, the second model generation module 1108 is further configured to: perform three-dimensional convolution processing on the output of the last instance of second processing to obtain an output of the second subnetwork model; and convert the output of the second subnetwork model into a triangular mesh model, to obtain the three-dimensional object model belonging to the object category, the three-dimensional object model satisfying the preset resolution condition.

In an embodiment, the three-dimensional model generation apparatus further includes a first subnetwork model training module. The first subnetwork model training module is configured to: obtain a plurality of three-dimensional sample models belonging to the object category, and normalize each three-dimensional sample model to a preset vector space to obtain a normalized sample; obtain, through conversion based on the normalized sample, first training data corresponding to a first resolution, and add noise to the first training data to obtain a first input sample; determine a first training iteration count, and determine, based on the first training iteration count, a first intensity sample in any round of first subnetwork model training process; and perform first iterative training on a first subnetwork model in a candidate network model to be trained by using the first training data, the first input sample, and the first intensity sample, to obtain a trained first subnetwork model at the end of training.

In an embodiment, the three-dimensional model generation apparatus further includes a second subnetwork model training module. The second subnetwork model training module is configured to: obtain a plurality of three-dimensional sample models belonging to the object category, and normalize each three-dimensional sample model to the preset vector space to obtain a normalized sample; obtain, through conversion based on the normalized sample, second training data corresponding to a second resolution, the second resolution being greater than the first resolution, and the first resolution being a resolution of the first training data for training the first subnetwork model; add noise to the second training data to obtain a second input sample; determine a second training iteration count, and determine, based on the second training iteration count, a second intensity sample in any round of second subnetwork model training process; and perform second iterative training on a second subnetwork model in the candidate network model by using the second training data, the second input sample, and the second intensity sample, to obtain a trained second subnetwork model at the end of training.

Each module in the three-dimensional model generation apparatus may be implemented entirely or partially by using software, hardware, or a combination thereof. Each module may be embedded in or independent of a processor in a computer device in a form of hardware, or may be stored in a memory in a computer device in a form of software, so that the processor may invoke the module to perform the operation corresponding to the module.

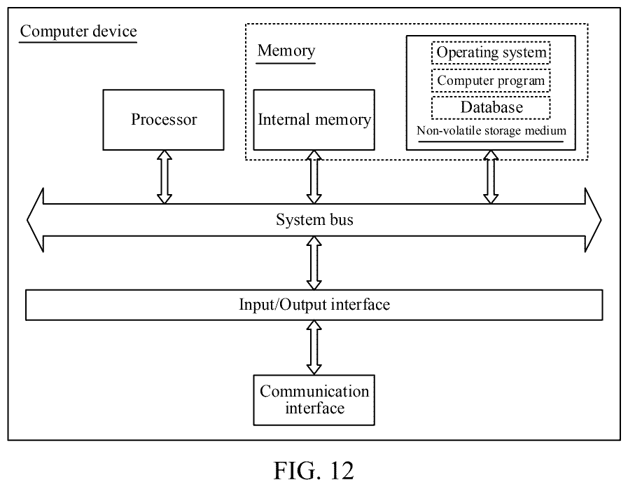

In an exemplary embodiment, a computer device is provided. The computer device may be a server or a terminal. A diagram of an internal structure of the computer device may be shown in FIG. 12. The computer device includes a processor, a memory, an input/output (I/O) interface, and a communication interface. The processor, the memory, and the input/output interface are connected through a system bus. The communication interface is connected to the system bus through the input/output interface. The processor of the computer device is configured to provide calculation and control capabilities. The memory of the computer device includes a non-volatile storage medium and an internal memory. The non-volatile storage medium has an operating system, a computer program, and a database stored therein. The internal memory provides a running environment for the operating system and the computer program in the non-volatile storage medium. The database of the computer device is configured to store data related to generation of a three-dimensional model. The input/output interface of the computer device is configured to exchange information between the processor and an external device. The communication interface of the computer device is configured to be connected to an external terminal for communication by using a network. The computer program, when executed by the processor, causes a three-dimensional model generation method to be implemented.

The structure shown in FIG. 12 is merely a block diagram of a partial structure related to the solutions of the present disclosure, and does not constitute a limitation on the computer device to which the solutions of the present disclosure are applied. Specifically, the computer device may include more or fewer components than those shown in the figure, have some components combined, or have a different component arrangement.

In an exemplary embodiment, a computer device is provided, including a memory and a processor. The memory has a computer program stored therein. The processor, when executing the computer program, implements the operations of the foregoing three-dimensional model generation method.

In an embodiment, a computer-readable storage medium is provided, having a computer program stored herein. The computer program, when executed by a processor, causes the operations of the foregoing three-dimensional model generation method to be implemented. In an embodiment, a computer program product is provided, including a computer program. The computer program, when executed by a processor, causes the operations of the foregoing three-dimensional model generation method to be implemented.

User information (including, but not limited to, user equipment information, user personal information, and the like) and data (including, but not limited to, data for analysis, stored data, displayed data, and the like) involved in the present disclosure are all information and data authorized by users or fully authorized by all parties, and collection, use, and processing of relevant data need to comply with relevant regulations.

A person of ordinary skill in the art may understand that all or a part of procedures of the method in the foregoing embodiments may be implemented by a computer program instructing relevant hardware. The computer program may be stored in a non-volatile computer-readable storage medium. When the computer program is executed, the procedures of the foregoing method embodiments may be performed. References to the memory, the database, or another medium used in the embodiments provided in the present disclosure may all include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache, or the like. For the purpose of illustration rather than limitation, the RAM may be in various forms, for example, a static random access memory (SRAM) or a dynamic random access memory (DRAM). The database involved in the embodiments provided in the present disclosure may include at least one of a relational database and a non-relational database. The non-relational database may include but is not limited to a blockchain-based distributed database and the like. The processor involved in the embodiments provided by the present disclosure may be but is not limited to a general-purpose processor, a central processing unit, a graphics processing unit, a digital signal processor, a programmable logic device, a quantum computing-based data processing logic device, and the like.

The technical features in the foregoing embodiments may be combined in any manner. To make the description brief, not all possible combinations of the technical features in the foregoing embodiments are described. However, provided that the combinations of the technical features do not conflict with each other, the combinations shall be considered as falling within the scope recorded in this specification.

The foregoing embodiments only describe several embodiments of the present disclosure, which are described specifically and in detail, but cannot be construed as a limitation on the patent scope of the present disclosure. For a person of ordinary skill in the art, several transformations and improvements can be made without departing from the idea of the present disclosure. These transformations and improvements shall fall within the protection scope of the present disclosure. Therefore, the patent protection scope of the present disclosure shall be subject to the appended claims.

What is claimed is:

1. A three-dimensional model generation method, performed by a computer device, the method comprising:
obtaining prompt information describing an object category, and determining a target network model matching the object category indicated by the prompt information, the target network model comprising a first subnetwork model and a second subnetwork model;
obtaining a first generation intensity, a second generation intensity, and a generation seed, the first generation intensity indicating a quantity of iteration rounds of first processing to be performed by the first subnetwork model, the second generation intensity indicating a quantity of iteration rounds of second processing to be performed by the second subnetwork model, the generation seed being a randomly generated number, each round of the first processing comprising at least one instance of first encoding/decoding processing, each round of the second processing comprising at least one instance of second encoding/decoding processing;
performing at least one round of the first processing based on the first generation intensity and the generation seed by using the first subnetwork model, to obtain an intermediate three-dimensional model; and
performing at least one round of the second processing based on the second generation intensity and the intermediate three-dimensional model by using the second subnetwork model, to obtain a three-dimensional object model that satisfies a preset resolution condition and that belongs to the object category.

2. The method according to claim 1, wherein the determining a target network model matching the object category indicated by the prompt information comprises:
determining the object category indicated by the prompt information; and
obtaining the target network model matching the object category from a network model pool, the network model pool comprising a plurality of trained network models for generating three-dimensional object models of multiple categories, and the target network model being configured to generate a three-dimensional object model belonging to the object category indicated by the prompt information.

3. The method according to claim 1, wherein the determining the object category indicated by the prompt information comprises:
obtaining a feature vector of each of a plurality of preset object category names to obtain a first feature set;
performing vectorized representation on the prompt information to determine at least one feature vector related to the prompt information, to obtain a second feature set;
calculating a similarity between each feature vector in the second feature set and each feature vector in the first feature set; and
determining an object category to which a target feature vector belongs as the object category indicated by the prompt information, the target feature vector being in the first feature set and corresponding to a maximum similarity.

4. The method according to claim 3, wherein the performing vectorized representation on the prompt information to determine at least one feature vector related to the prompt information, to obtain a second feature set comprises:
performing word segmentation processing on the prompt information to obtain a plurality of word units in the prompt information; and
extracting a feature vector of the prompt information and a feature vector of each word unit to obtain the second feature set.

5. The method according to claim 1, wherein the performing at least one round of first processing based on the first generation intensity and the generation seed by using the first subnetwork model, to obtain an intermediate three-dimensional model comprises:
determining a first quantity of times based on the first generation intensity, performing the first processing for the first quantity of times by using the first subnetwork model, and obtaining the intermediate three-dimensional model based on an output of a last instance of the first processing, each round of the first processing comprising at least two instances of the first encoding/decoding processing, and a current instance of the first encoding/decoding processing in a current round comprising:
obtaining a first encoded feature in the current instance of the first encoding/decoding processing, wherein first encoded features in instances of the first encoding/decoding processing in the current round are the same and determined based on a round number corresponding to the current round;
obtaining a second encoded feature in the current instance of the first encoding/decoding processing, a second encoded feature in a first instance of the first encoding/decoding processing in a first round being determined based on the generation seed, and a second encoded feature in a non-first instance of the first encoding/decoding processing in a non-first round being an output of a previous instance of the first encoding/decoding processing;
performing at least one instance of hierarchical encoding processing based on different spatial resolution levels and based on the first encoded feature and the second encoded feature, to obtain a first encoding processing result;
performing at least one instance of fusion processing based on the first encoding processing result and the first encoded feature, to obtain a first intermediate processing result; and
performing at least one instance of hierarchical decoding processing based on different spatial resolution levels and based on the first intermediate processing result and an output of each instance of the hierarchical encoding processing, to obtain an output of the current instance of the first encoding/decoding processing.

6. The method according to claim 5, wherein determining operations for the first encoded feature in the current round comprise:
determining a first value to be encoded in the current round based on the round number of the current round;
expanding the first value into a feature vector of a preset dimension; and
performing at least one linear transformation on the feature vector of the preset dimension to obtain the first encoded feature.

7. The method according to claim 5, wherein determining operations for the second encoded feature in the first instance of the first encoding/decoding processing in the first round comprise:
generating a first tensor of a preset shape based on the generation seed by using a Gaussian function; and
performing three-dimensional convolution processing on the first tensor of the preset shape to obtain the second encoded feature located within a three-dimensional space.

8. The method according to claim 5, wherein the performing at least one instance of the hierarchical encoding processing based on different spatial resolution levels and based on the first encoded feature and the second encoded feature, to obtain a first encoding processing result comprises:
obtaining an input model feature of a current encoding layer, an input model feature of a first encoding layer being the second encoded feature, and an input model feature of a non-first encoding layer being an output of a previous encoding layer;
performing the fusion processing on the first encoded feature and the input model feature of the current encoding layer to obtain a first fusion result, and downsampling the first fusion result to obtain an output of the current encoding layer, to complete the hierarchical encoding processing of the current encoding layer; and
continuing to perform the hierarchical encoding processing of a next encoding layer until a last encoding layer, and using a first fusion result of the last encoding layer as an output of the last encoding layer, the output of the last encoding layer being the first encoding processing result.

9. The method according to claim 5, wherein the performing at least one instance of the fusion processing based on the first encoding processing result and the first encoded feature, to obtain a first intermediate processing result comprises:
obtaining an input model feature in a current fusion process, an input model feature in a first fusion process being the first encoding processing result, and an input model feature in a non-first fusion process being an output of a previous instance of the fusion processing;
performing the fusion processing on the first encoded feature and the input model feature in the current fusion process to obtain a second fusion result, to complete a current instance of the fusion processing; and
continuing to perform a next instance of the fusion processing until a last instance of the fusion processing is completed, and using a second fusion result of the last instance of the fusion processing as the first intermediate processing result.

10. The method according to claim 5, wherein the performing at least one instance of hierarchical decoding processing based on different spatial resolution levels and based on the first intermediate processing result and an output of each instance of the hierarchical encoding processing, to obtain an output of the current instance of the first encoding/decoding processing comprises:
obtaining an input model feature of a current decoding layer, an input model feature of a first decoding layer being the first intermediate processing result, and an input model feature of a non-first decoding layer comprising an output of a previous decoding layer and an output of an encoding layer corresponding to a same resolution;
performing fusion processing on the first encoded feature and the input model feature of the current decoding layer to obtain a third fusion result, and upsampling the third fusion result to obtain an output of the current decoding layer, to complete hierarchical decoding of the current decoding layer; and
continuing to perform the hierarchical decoding processing of a next decoding layer until a last decoding layer, and using a third fusion result of the last decoding layer as an output of the last decoding layer, the output of the last decoding layer being the output of the current instance of the first encoding/decoding processing.

11. The method according to claim 1, wherein the performing at least one round of second processing based on the second generation intensity and the intermediate three-dimensional model by using the second subnetwork model, to obtain a three-dimensional object model that satisfies a preset resolution condition and that belongs to the object category comprises:
determining a second quantity of times based on the second generation intensity, performing second processing for the second quantity of times by using the second subnetwork model, and obtaining the three-dimensional object model based on an output of a last instance of the second processing, each round of the second processing comprising at least two instances of the second encoding/decoding processing, and a current instance of the second encoding/decoding processing in a current round comprising:
obtaining a third encoded feature in the current instance of the second encoding/decoding processing, third encoded features in instances of the second encoding/decoding processing in the current round being the same and determined based on a round number corresponding to the current round;
obtaining a fourth encoded feature in the current instance of the second encoding/decoding processing, a fourth encoded feature in a first instance of the second encoding/decoding processing in a first round being determined based on the intermediate three-dimensional model, and a fourth encoded feature in a non-first instance of the second encoding/decoding processing in a non-first round being an output of a previous instance of the second encoding/decoding processing;
performing at least one instance of hierarchical encoding processing based on different spatial resolution levels and based on the third encoded feature and the fourth encoded feature, to obtain a second encoding processing result;
performing at least one instance of the fusion processing based on the second encoding processing result and the third encoded feature, to obtain a second intermediate processing result; and
performing at least one instance of hierarchical decoding processing based on different spatial resolution levels and based on the second intermediate processing result and an output of each instance of the hierarchical encoding processing, to obtain an output of the current instance of the second encoding/decoding processing.

12. The method according to claim 11, wherein determining operations for the fourth encoded feature in the first instance of the second encoding/decoding processing in the first round comprise:
upsampling the intermediate three-dimensional model to obtain a second tensor;
using an element that is in the second tensor and whose value is greater than a preset value as a first element, and using an element in the second tensor other than the first element as a second element;
replacing a value of the first element with a randomly generated number to obtain an updated second tensor; and
performing three-dimensional convolution processing on the updated second tensor to obtain the fourth encoded feature located within the three-dimensional space, a second element in the updated second tensor not participating in three-dimensional convolution processing.

13. The method according to claim 11, wherein the obtaining the three-dimensional object model based on an output of a last instance of the second processing comprises:
performing three-dimensional convolution processing on the output of the last instance of the second processing to obtain an output of the second subnetwork model; and
converting the output of the second subnetwork model into a triangular mesh model, to obtain the three-dimensional object model belonging to the object category, the three-dimensional object model satisfying the preset resolution condition.

14. The method according to claim 1, wherein training operations for the first subnetwork model comprise:
obtaining a plurality of three-dimensional sample models belonging to the object category, and normalizing each three-dimensional sample model to a preset vector space to obtain a normalized sample;
obtaining, through conversion based on the normalized sample, first training data corresponding to a first resolution, and adding noise to the first training data to obtain a first input sample;
determining a first training iteration count, and determining, based on the first training iteration count, a first intensity sample in a round of first subnetwork model training process; and
performing first iterative training on a first subnetwork model in a candidate network model to be trained by using the first training data, the first input sample, and the first intensity sample, to obtain a trained first subnetwork model at the end of training.

15. The method according to claim 1, wherein training operations for the second subnetwork model comprise:
obtaining a plurality of three-dimensional sample models belonging to the object category, and normalizing each three-dimensional sample model to the preset vector space to obtain a normalized sample;
obtaining, through conversion based on the normalized sample, second training data corresponding to a second resolution, the second resolution being greater than the first resolution, and the first resolution being a resolution of the first training data for training the first subnetwork model;
adding noise to the second training data to obtain a second input sample;
determining a second training iteration count, and determining, based on the second training iteration count, a second intensity sample in a round of second subnetwork model training process; and
performing second iterative training on a second subnetwork model in the candidate network model by using the second training data, the second input sample, and the second intensity sample, to obtain a trained second subnetwork model at the end of training.

16. A three-dimensional model generation apparatus, comprising:
a memory and a processor, the memory having a computer program stored therein, and the processor being configured, when executing the computer program, to implement:
obtaining prompt information describing an object category, and determining a target network model matching the object category indicated by the prompt information, the target network model comprising a first subnetwork model and a second subnetwork model;
obtaining a first generation intensity, a second generation intensity, and a generation seed, the first generation intensity indicating a quantity of iteration rounds of first processing to be performed by the first subnetwork model, the second generation intensity indicating a quantity of iteration rounds of second processing to be performed by the second subnetwork model, the generation seed being a randomly generated number, each round of the first processing comprising at least one instance of first encoding/decoding processing, each round of the second processing comprising at least one instance of second encoding/decoding processing;
performing at least one round of the first processing based on the first generation intensity and the generation seed by using the first subnetwork model, to obtain an intermediate three-dimensional model; and
performing at least one round of the second processing based on the second generation intensity and the intermediate three-dimensional model by using the second subnetwork model, to obtain a three-dimensional object model that satisfies a preset resolution condition and that belongs to the object category.

17. The apparatus according to claim 16, wherein the determining a target network model matching the object category indicated by the prompt information comprises:
determining the object category indicated by the prompt information; and
obtaining the target network model matching the object category from a network model pool, the network model pool comprising a plurality of trained network models for generating three-dimensional object models of multiple categories, and the target network model being configured to generate a three-dimensional object model belonging to the object category indicated by the prompt information.

18. The apparatus according to claim 16, wherein the determining the object category indicated by the prompt information comprises:
obtaining a feature vector of each of a plurality of preset object category names to obtain a first feature set;
performing vectorized representation on the prompt information to determine at least one feature vector related to the prompt information, to obtain a second feature set;
calculating a similarity between each feature vector in the second feature set and each feature vector in the first feature set; and
determining an object category to which a target feature vector belongs as the object category indicated by the prompt information, the target feature vector being in the first feature set and corresponding to a maximum similarity.

19. The apparatus according to claim 16, wherein the performing at least one round of first processing based on the first generation intensity and the generation seed by using the first subnetwork model, to obtain an intermediate three-dimensional model comprises:
determining a first quantity of times based on the first generation intensity, performing the first processing for the first quantity of times by using the first subnetwork model, and obtaining the intermediate three-dimensional model based on an output of a last instance of the first processing, each round of the first processing comprising at least two instances of the first encoding/decoding processing, and a current instance of the first encoding/decoding processing in a current round comprising:
obtaining a first encoded feature in the current instance of the first encoding/decoding processing, wherein first encoded features in instances of the first encoding/decoding processing in the current round are the same and determined based on a round number corresponding to the current round;
obtaining a second encoded feature in the current instance of the first encoding/decoding processing, a second encoded feature in a first instance of the first encoding/decoding processing in a first round being determined based on the generation seed, and a second encoded feature in a non-first instance of the first encoding/decoding processing in a non-first round being an output of a previous instance of the first encoding/decoding processing;
performing at least one instance of hierarchical encoding processing based on different spatial resolution levels and based on the first encoded feature and the second encoded feature, to obtain a first encoding processing result;
performing at least one instance of fusion processing based on the first encoding processing result and the first encoded feature, to obtain a first intermediate processing result; and
performing at least one instance of hierarchical decoding processing based on different spatial resolution levels and based on the first intermediate processing result and an output of each instance of the hierarchical encoding processing, to obtain an output of the current instance of the first encoding/decoding processing.

20. A non-transitory computer-readable storage medium, having a computer program stored therein, the computer program, when executed by a processor, causing the processors to implement:
obtaining prompt information describing an object category, and determining a target network model matching the object category indicated by the prompt information, the target network model comprising a first subnetwork model and a second subnetwork model;
obtaining a first generation intensity, a second generation intensity, and a generation seed, the first generation intensity indicating a quantity of iteration rounds of first processing to be performed by the first subnetwork model, the second generation intensity indicating a quantity of iteration rounds of second processing to be performed by the second subnetwork model, the generation seed being a randomly generated number, each round of the first processing comprising at least one instance of first encoding/decoding processing, each round of the second processing comprising at least one instance of second encoding/decoding processing;
performing at least one round of the first processing based on the first generation intensity and the generation seed by using the first subnetwork model, to obtain an intermediate three-dimensional model; and
performing at least one round of the second processing based on the second generation intensity and the intermediate three-dimensional model by using the second subnetwork model, to obtain a three-dimensional object model that satisfies a preset resolution condition and that belongs to the object category.
